(19) United States
(12) Patent Application Publication
(10) Pub. No.: US 2026/0292240 A1
(43) Pub. Date: Sep. 24, 2026

(54) TEMPLATE MATCHING-BASED PREDICTION

(71) Applicant: Tencent Technology (Shenzhen) Company Limited, Shenzhen (CN)

(72) Inventors: Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/683,464

(22) Filed: May 20, 2026

Related U.S. Application Data
(63) Continuation of application No. PCT/CN2025/076891, filed on Feb. 11, 2025.

(30) Foreign Application Priority Data
Mar. 15, 2024 (CN) 202410306896.X

(51) Int. Cl. H04N 19/56; H04N 19/105; H04N 19/176

(52) U.S. Cl. CPC H04N 19/56; H04N 19/105; H04N 19/176

(57) ABSTRACT

In a video decoding method, a first starting search point in a first reference picture is determined based on a first vector included in a first vector prediction list of a current block in a current picture. Based on the first starting search point, a first reference region of the current block is searched for a second vector. In the method, a second starting search point in a second reference picture is determined based on a third vector included in the first vector prediction list or a second vector prediction list of the current block. Based on the second starting search point, a second reference region of the current block is searched for a fourth vector. In the method, a prediction block is obtained based on the second vector and the fourth vector. The current block is reconstructed based on the prediction block.

### RELATED APPLICATIONS

The present application is a continuation of International Application No. PCT/CN2025/076891, filed on Feb. 11, 2025, which claims priority to Chinese Patent Application No. 202410306896.X, filed on Mar. 15, 2024, and entitled “TEMPLATE MATCHING-BASED PREDICTION METHOD AND APPARATUS, DEVICE, AND STORAGE MEDIUM.” The entire disclosures of the prior applications are hereby incorporated by reference.

### FIELD OF THE TECHNOLOGY

This disclosure relates to the field of encoding and decoding technologies, including a template matching-based prediction method and apparatus, a device, and a storage medium.

### BACKGROUND

In various applications, an inter prediction mode or an intra block copy mode may be based on searching a reference region for a picture block closest to a current to-be-encoded block through template matching, and then encode and transmit vector information (for example, a motion vector indicating a position of a prediction block) to a decoder side, so that the decoder side can obtain the prediction block of the current block in the reference region through the vector information.

However, the vector information is encoded and transmitted to the decoder side, which may add burden to the transmission of the encoded information.

### SUMMARY

Embodiments of this disclosure include a template matching-based prediction method and apparatus, a device, and a storage medium, to increase transmission efficiency.

According to a first aspect, an embodiment of this disclosure includes a video decoding method. In the method, a first starting search point in a first reference picture is determined based on a first vector included in a first vector prediction list of a current block in a current picture. Based on the first starting search point, a first reference region of the current block is searched for a second vector through a template of reconstructed pixels adjacent to the current block. In the method, a second starting search point in a second reference picture is determined based on a third vector included in the first vector prediction list or a second vector prediction list of the current block that is different from the first vector prediction list. Based on the second starting search point, a second reference region of the current block is searched for a fourth vector through the template of reconstructed pixels adjacent to the current block. In the method, a prediction block of the current block is obtained based on fusing a first prediction block indicated by the second vector and a second prediction block indicated by the fourth vector. The current block is reconstructed based on the prediction block.

According to a second aspect, an embodiment of this disclosure includes a encoding method. In the method, a first starting search point in a first reference picture is determined based on a first vector included in a first vector prediction list of a current block in a current picture. Based on the first starting search point, a first reference region of the current block is searched for a second vector through a template of reconstructed pixels adjacent to the current block. In the method, a second starting search point in a second reference picture is determined based on a third vector included in the first vector prediction list or a second vector prediction list of the current block that is different from the first vector prediction list. Based on the second starting search point, a second reference region of the current block is searched for a fourth vector through the template of reconstructed pixels adjacent to the current block. In the method, a prediction block of the current block is obtained based on fusing a first prediction block indicated by the second vector and a second prediction block indicated by the fourth vector. The current block is encoded into a bitstream based on the prediction block.

According to a third aspect, an embodiment of this disclosure includes a non-transitory computer-readable storage medium storing instructions which, when executed by a processor, cause the processor to perform a method of encoding a bitstream. In the method, a first starting search point in a first reference picture is determined based on a first vector included in a first vector prediction list of a current block in a current picture. Based on the first starting search point, a first reference region of the current block is searched for a second vector through a template of reconstructed pixels adjacent to the current block. In the method, a second starting search point in a second reference picture is determined based on a third vector included in the first vector prediction list or a second vector prediction list of the current block that is different from the first vector prediction list. Based on the second starting search point, a second reference region of the current block is searched for a fourth vector through the template of reconstructed pixels adjacent to the current block. In the method, a prediction block of the current block is obtained based on fusing a first prediction block indicated by the second vector and a second prediction block indicated by the fourth vector. The current block is encoded into a bitstream based on the prediction block. In the method, the encoded bitstream is transmitted.

According to a fourth aspect, an embodiment of this disclosure includes a template matching-based prediction method, including: determining a first starting search point based on a first vector included in a first vector prediction (VP) in a vector prediction (VP) list of a current block; searching, based on the first starting search point, a reference region of the current block for a second vector of the current block through a template formed by reconstructed pixels adjacent to the current block; and determining a prediction block of the current block based on the second vector.

According to a fifth aspect, an embodiment of this disclosure includes a template matching-based prediction apparatus, including: a first determining unit, configured to determine a first starting search point based on a first vector included in a first vector prediction (VP) in a vector prediction (VP) list of a current block; a searching unit, configured to search, based on the first starting search point, a reference region of the current block for a second vector of the current block through a template formed by reconstructed pixels adjacent to the current block; and a second determining unit, configured to determine a prediction block of the current block based on the second vector.

According to a sixth aspect, an embodiment of this disclosure includes an electronic device, including: a processor, configured to execute computer instructions; and a computer-readable storage medium, having computer instructions stored therein, the computer-readable instructions being configured to be loaded and executed by the processor, to implement the method according to the first aspect described above.

According to a seventh aspect, an embodiment of this disclosure includes a non-transitory computer-readable storage medium. The non-transitory computer-readable storage medium has computer instructions stored therein, the computer instructions, when read and executed by a processor of a computer device, causing the computer device to perform the method according to the first aspect described above.

According to an eighth aspect, an embodiment of this disclosure includes a computer program product or a computer program, the computer program product or the computer program including computer instructions, the computer instructions being stored in a non-transitory computer-readable storage medium. Processing circuitry (e.g., a processor) of a computer device reads the computer instructions from the non-transitory computer-readable storage medium, and the processor executes the computer instructions, so that the computer device performs the method according to the first aspect described above.

According to a ninth aspect, an embodiment of this disclosure includes a bitstream, the bitstream being the bitstream generated through the method according to the foregoing first aspect described above.

In one or more embodiments of this disclosure, the template matching-based prediction method includes: determining a first starting search point based on a first vector included in a first vector prediction (VP) in a vector prediction (VP) list of a current block; searching a reference region of the current block for a second vector of the current block through a template formed by reconstructed pixels adjacent to the current block based on the first starting search point; and determining a prediction block of the current block based on the second vector. In some examples, through the template matching-based prediction method, a reference region of the current block may be searched for a second vector of the current block through a template constructed by reconstructed pixels adjacent to the current block based on the first starting search point, and then a prediction block of the current block is determined based on the second vector. An encoder side and a decoder side may both determine the prediction block of the current block by using the template matching-based prediction method, namely, the encoder side may not need to transfer vector information to the decoder side, so that a bit rate occupied during transfer of the motion information can be saved, thereby increasing a bit rate.

In addition, a second vector is obtained by searching based on the first starting search point, and then the prediction block of the current block is determined based on the second vector. In some examples, the second vector may be obtained based on modifying the first vector, so that a prediction block with relatively high quality can be obtained, thereby improving a prediction effect of the current block.

### BRIEF DESCRIPTION OF THE DRAWINGS

FIG. 1 is a schematic block diagram of a video encoding and decoding system according to an embodiment of this disclosure.

FIG. 2 is a schematic block diagram of a video encoder according to an embodiment of this disclosure.

FIG. 3 is a schematic structural diagram of a relationship between a coding tree unit and a coding unit (CU) according to this disclosure.

FIG. 4 is a schematic block diagram of a video decoder according to an embodiment of this disclosure.

FIG. 5 is an example of an integer pixel and a fractional pixel according to an embodiment of this disclosure.

FIG. 6 is an example of a space-domain MVP according to an embodiment of this disclosure.

FIG. 7 is an example of a three-step search method according to an embodiment of this disclosure.

FIGS. 8A-8B are examples of search shapes of a four-step search method according to an embodiment of this disclosure.

FIGS. 9A-9B are examples of search shapes of a diamond search method according to an embodiment of this disclosure.

FIGS. 10A-10C are examples of search shapes of a hexagon search method according to an embodiment of this disclosure.

FIG. 11 is a schematic flowchart of a template matching-based prediction method according to an embodiment of this disclosure.

FIG. 12 is an example of a template according to an embodiment of this disclosure.

FIG. 13 is an example of a template of a search point and a template of a current block according to an embodiment of this disclosure.

FIGS. 14A-14G are examples of search shapes included in a search method according to an embodiment of this disclosure.

FIGS. 15A-15B are examples of a plurality of template regions according to an embodiment of this disclosure.

FIGS. 16A-16B are other examples of a plurality of template regions according to an embodiment of this disclosure.

FIG. 17 is a schematic block diagram of a template matching-based prediction apparatus according to an embodiment of this disclosure.

FIG. 18 is a schematic block diagram of an electronic device according to an embodiment of this disclosure.

### DETAILED DESCRIPTION

Technical solutions in embodiments of this disclosure are described below with reference to accompanying drawings.

Solutions provided in this disclosure relate to the field of digital compression technologies.

A digital video compression technology may be usable to compress huge volumes of digital video data, to facilitate transmission, storage, and the like.

Solutions provided in this disclosure may be applied to the field of digital video encoding technologies.

The field of digital video encoding technologies may include, but is not limited to, at least one of the following: the field of picture encoding and decoding, the field of video encoding and decoding, the field of hardware video encoding and decoding, the field of specific circuit video encoding and decoding, or the field of real-time video encoding and decoding. In addition, the solutions provided in this disclosure may be combined with the following standards: an audio video coding standard (AVS), the second generation AVS standard (AVS2), or the third generation AVS standard (AVS3). For example, the standards include, but are not limited to, an H.264/audio video coding (AVC) standard, an H.265/high efficiency video coding (HEVC) standard, and an H.266/versatile video coding (VVC) standard. In addition, the solutions provided in this disclosure may be configured to perform lossy compression on a picture, or may be configured to perform lossless compression on the picture. The lossless compression may be visually lossless compression, or may be mathematically lossless compression.

To facilitate understanding of one or more technical solutions provided in this disclosure, relevant terms are described below. Descriptions of terms in this disclosure are provided as examples only and are not intended to limit the scope of the disclosure.

Instantaneous decoding refresh (IDR) frame: In a video encoding algorithm, pictures are organized in a unit of a sequence. A first picture in a sequence is referred to as an IDR frame, and IDR pictures are all I-frames. The IDR frame may also be referred to as an IDR picture.

I-frame: The IDR frame may cause a reference picture list (Decoded Picture Buffer, DPB) to be cleared, but an I-frame does not. The IDR picture may be an I-frame, but the I-frame may not necessarily be an IDR frame. A large quantity of I-frames may exist in a sequence, and frames following the I-frames may use a frame between the I-frames as a motion reference.

P-frame: The P-frame may correspond to a forward predictive coding frame. The P-frame may record a difference between a current frame and a previous key frame (or the P-frame), and a difference defined in the current frame may be superimposed with a previously cached picture during decoding to generate a final picture.

B-frame: The B-frame may correspond to a bidirectional predictive interpolation coding frame. The B-frame is a bidirectional difference frame. For example, the B-frame may record a difference between the current frame and previous and forward frames. The B-frame may be used as a reference frame for other B-frames, or may not be used as the reference frame for other B-frames.

Quantization parameter (QP): A bit rate control algorithm may correspond to output a target bit rate by adjusting a quantization parameter of discrete cosine transform. In some examples, the quantization parameter (QP) may reflect compression of spatial details. If the QP is small, most details are retained. If the QP increases, some details are lost, a bit rate is reduced, picture distortion is aggravated while quality is degraded. For example, the QP and the bit rate are in an inverse relationship, and this inverse relationship becomes more pronounced as the complexity of a video source increases.

Intra prediction: a prediction block coded based on intra prediction may correspond to a block formed based on an encoded reconstructed block and a current block.

Inter prediction: Inter prediction may include motion estimation (a motion search method, a motion estimation criterion, sub-pixel interpolation, and motion vector estimation) and motion compensation, which may be reference and predictive interpolation compensation of a group of pictures (GOP) in granularity timing.

Sum of absolute difference (SAD): It may correspond to a sum of absolute differences.

Sum of absolute error (SAE): It may correspond to a sum of absolute errors.

Sum of absolute transformed difference (SATD): It may correspond to, for example, absolute values are summed after Hadamard transform.

Motion compensation (MC): A data volume between consecutive pictures may be reduced by predicting a motion trajectory of an object in a picture and compensating for displacement of the object.

Motion estimation (ME): Redundant information in a time dimension may be removed by searching for a correlation between adjacent pictures and calculating a motion vector between blocks, to further improve compression efficiency.

BD-rate: It may correspond to a metric for evaluating the performance of video coding algorithms, which may indicate a variation in a bit rate and a peak signal-to-noise ratio (PSNR) of videos encoded through a new algorithm compared with an original algorithm.

Rate distortion optimization (RDO): A large quantity of modes may be available during encoding. Some modes achieve low picture distortion but result in a high bit rate, while others exhibit high picture distortion but a low bit rate. Based on this, the distortion can be minimized without exceeding a specified maximum bit rate. In rate distortion optimization of video coding, a maximum bit rate may be used as a constraint, distortion may be used as an optimization objective, and then the Lagrange multiplier method may be used to search for an optimal coding parameter.

Macroblock: It may correspond to a basic unit of coding. A picture may be divided into macroblocks before processing. For example, a picture may be divided into macroblocks in units of a specified size (16×16 in H.264), and encoding is performed on a block basis during the encoding.

Reference picture: It may correspond to a reconstructed picture in video coding and decoding that is used as reference data for other pictures and provides inter-picture reference data for other pictures during encoding/decoding.

Motion vector (MV): It may correspond to a two-dimensional vector and configured to describe a position offset that occurs when a to-be-encoded block in an encoder moves from a position of the to-be-encoded block to another position.

Motion search (MS): It may correspond to a process in which a current to-be-encoded block searches for an optimal matching block in a reference picture according to a specified algorithm.

Motion vector prediction (MVP): It may correspond to predicting a current MV according to a specified algorithm based on available information.

Terms used in implementations of this disclosure are merely used for explaining one or more embodiments of this disclosure, but are not intended to limit this disclosure.

For example, a term “and/or” herein is merely an association relationship describing associated objects, which means that three relationships may exist, for example, A and/or B may indicate three cases: A exists alone, both A and B exist, and B exists alone. A term “at least one” only describes a combination relationship of listed objects, which indicates that one or more may exist, for example, at least one of the following: A, B, or C may indicate the following combinations: only A exists, only B exists, only C exists, both A and B exist, both A and C exist, both B and C exist, and A, B, and C all exist. A term “a plurality of” means two or more. The character “/” generally indicates an “or” relationship between a preceding associated object and a succeeding associated object.

For another example, a term “corresponding to” may indicate that a direct correspondence or an indirect correspondence exists between the two objects, may indicate that an association relationship exists between the two objects, or may indicate a relationship of indicating and being indicated, a relationship of configuring and being configured, or the like. A term “indication” may be a direct indication or an indirect indication, or may indicate that an association relationship exists. For example, A indicates B, which may indicate that A directly indicates B, for example, B may be obtained through A; or may indicate that A indirectly indicates B, for example, A indicates C, and B may be obtained through C; or may indicate that an association relationship exists between A and B. A term “pre-defined” or “pre-configured” may indicate that corresponding code, table, or other relevant information that may be configured to indicate may be pre-stored in the device, or may be agreed on in a protocol. The “protocol” may refer to a standard protocol in the field. A term “when” may be interpreted as a similar description such as “provided that” or “if” or “at the time that” or “in response to”. Similarly, depending on the context, a phrase “if determining” or “if detecting (a stated condition or event)” may be interpreted as a similar description such as “when determining” or “in response to determining” or “when detecting (the stated condition or event)” or “in response to detecting (the stated condition or event)”. Terms “first”, “second”, “third”, “fourth”, “A^{th}”, “B^{th}”, and the like are configured to distinguish between different objects, but are not intended to describe a specific sequence. Terms “include”, “have”, and any variant thereof are intended to cover a non-exclusive (or non-excludable) inclusion. A digital video compression technology may correspond to compress huge volumes of digital video data, to facilitate transmission, storage, and the like.

For ease of understanding, a video encoding and decoding system in an embodiment of this disclosure is first described with reference to FIG. 1.

FIG. 1 is a schematic block diagram of a video encoding and decoding system according to an embodiment of this disclosure.

As shown in FIG. 1, the video encoding and decoding system 100 includes an encoding device 110 and a decoding device 120.

The encoding device 110 is configured to encode (which may be understood as compression) video data to generate a bitstream, and transmit the bitstream to the decoding device 120. The decoding device 120 decodes the bitstream generated by the encoding device 110 through encoding, to obtain decoded video data.

The encoding device 110 may be understood as a device having a video encoding function, and the decoding device 120 may be understood as a device having a video decoding function. To be specific, in this embodiment of this disclosure, the encoding device 110 and the decoding device 120 include a wider range of apparatuses, for example, a smartphone, a desktop computer, a mobile computing apparatus, a notebook (for example, laptop) computer, a tablet computer, a set-top box, a television, a camera, a display apparatus, a digital media player, a video game console, and an on-board computer.

The encoding device 110 may transmit the encoded video data (for example, a bitstream) to the decoding device 120 through a channel 130.

The channel 130 may include one or more media and/or apparatuses that can transmit the encoded video data from the encoding device 110 to the decoding device 120. The channel 130 may include one or more communication media that enable the encoding device 110 to transmit the encoded video data directly to the decoding device 120 in real time. The encoding device 110 may modulate the encoded video data based on a communication standard, and transmit the modulated video data to the decoding device 120. The communication media include a wireless communication medium, for example, a radio-frequency spectrum. The communication media may further include a wired communication medium, for example, one or more physical transmission lines. The channel 130 may include a storage medium. The storage medium may store video data encoded by the encoding device 110. The storage medium includes various local access data storage media, for example, an optical disk, a DVD, and a flash memory. In one or more embodiments, the decoding device 120 may obtain the encoded video data from the storage medium. The channel 130 may include a storage server. The storage server may store the video data encoded by the encoding device 110. In this example, the decoding device 120 may download the stored encoded video data from the storage server. In some embodiments, the storage server may store the encoded video data and may transmit the encoded video data to the decoding device 120, for example, a web server (for example, for a website) or a file transfer protocol (FTP) server.

The encoding device 110 includes a video encoder 112 and an output interface 113. The output interface 113 may include a modulator/demodulator (a modem) and/or a transmitter. The video encoder 112 directly transmits the encoded video data to the decoding device 120 through the output interface 113. The encoded video data may be further stored on a storage medium or a storage server for subsequent reading by the decoding device 120.

In addition to the video encoder 112 and the output interface 113, the encoding device 110 may further include a video source 111. The video source 111 may include at least one of a video capture apparatus (for example, a video camera), a video file, a video input interface, or a computer graphics system. The video input interface is configured to receive video data from a video content provider. The computer graphics system is configured to generate video data. The video encoder 112 encodes video data from the video source 111, to generate a bitstream. The video data may include one or more pictures or a sequence of pictures. The bitstream includes encoding information of the picture or the sequence of pictures in a form of a bitstream. The encoding information may include encoded picture data and associated data. The associated data may include a sequence parameter set (SPS), a picture parameter set (PPS), and another syntactic structure. The SPS may include parameters applied to one or more sequences. The PPS may include parameters applied to one or more pictures. The syntactic structure refers to a collection of zero or more syntax elements arranged in a specified order in the bitstream.

The decoding device 120 includes an input interface 121 and a video decoder 122. The input interface 121 may include a receiver and/or a modem. The input interface 121 may receive the encoded video data through the channel 130. The video decoder 122 is configured to decode the encoded video data, to obtain decoded video data.

In addition to the input interface 121 and the video decoder 122, the decoding device 120 may further include a display apparatus 123. After obtaining the decoded video data, the video decoder 122 transmits the decoded video data to the display apparatus 123. The display apparatus 123 displays the decoded video data. The display apparatus 123 may be integrated with the decoding device 120 or external to the decoding device 120. The display apparatus 123 may include a plurality of display apparatuses, for example, a liquid crystal display (LCD), a plasma display, an organic light-emitting diode (OLED) display, or another type of display apparatus.

FIG. 1 is merely an example of this disclosure, and is not to be interpreted as limitations of this disclosure. For example, the technical solution of one or more embodiments of this disclosure is not limited to a system framework shown in FIG. 1. For example, the technology of this disclosure may be further applied to one-sided video encoding or one-sided video decoding.

A video encoding framework involved in one or more embodiments of this disclosure is described below.

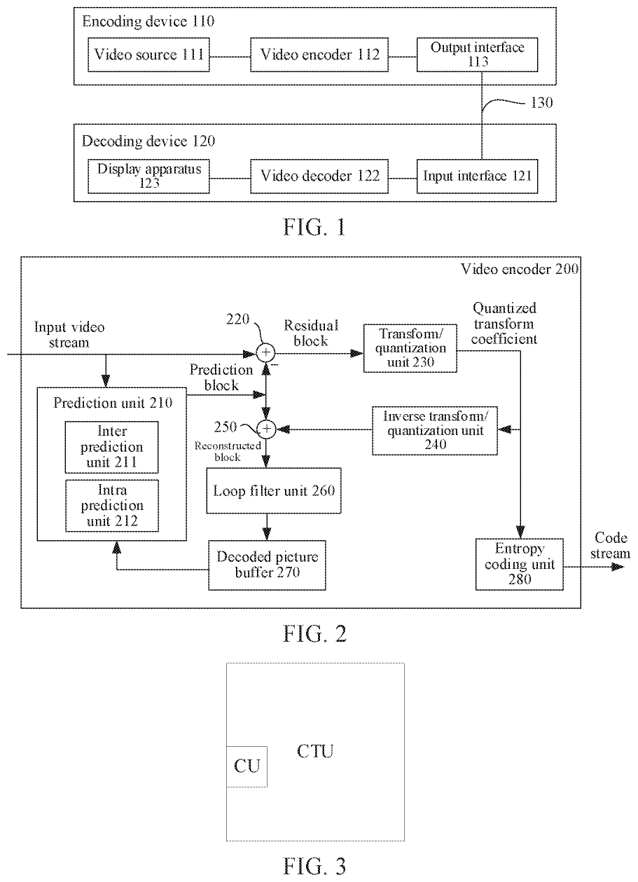

FIG. 2 is a schematic block diagram of a video encoder 200 according to an embodiment of this disclosure.

The video encoder 200 may be applied to picture data in a luminance-chrominance (YCbCr, YUV) format. For example, a YUV ratio may be 4:2:0, 4:2:2, or 4:4:4, where Y represents the luminance (Luma), Cb (U) represents blue chrominance, Cr (V) represents red chrominance, and U and V represent chroma for describing colors and saturation. For example, in a color format, 4:2:0 represents that every 4 pixels have 4 luminance components and 2 chrominance components (YYYYCbCr), 4:2:2 represents that every 4 pixels have 4 luminance components and 4 chrominance components (YYYYCbCrCbCr), and 4:4:4 represents full pixel display (YYYYCbCrCbCrCbCrCbCr). In some examples, the video encoder may also be applied to picture data in a red-green-blue (RGB) format. Examples described above are non-limiting examples and are not intended to limit the scope of this disclosure.

After reading a video stream, the video encoder 200 may divide each picture frame in the video stream into several coding tree units (CTUs). In some examples, a CTU may be referred to as a tree block, a largest coding unit (LCU), or a coding tree block (CTB). A size of one CTU may be, for example 128×128, 64×64, or 32×32.

FIG. 3 is a schematic structural diagram of a relationship between a coding tree unit and a CU according to this disclosure.

As shown in FIG. 3, one CTU may be further divided into several CUs for encoding. Each of the CUs may be a rectangular block or a square block. The CU may be further divided into a prediction unit (PU) and a transform unit (TU), thereby separating encoding, prediction, and transformation for more flexible processing. In an example, the CTU is divided into the CUs through a tree (for example, a quadtree), and the CU is divided into the TU and the PU through a tree (for example, a quadtree).

The video encoder and a video decoder may support various PU sizes.

Assuming that a size of a specific CU is 2N×2N, the video encoder and the video decoder may support the PU with a size of 2N×2N or N×N for intra prediction, and support a symmetric PU of 2N×2N, 2N×N, N×2N, N×N, or a similar size for inter prediction. The video encoder and the video decoder may further support asymmetric PUs of 2N×nU, 2N×nD, nL×2N, and nR×2N for inter prediction.

As shown in FIG. 2, the video encoder 200 may include a PU 210, a residual unit 220, a transform/quantization unit 230, an inverse transform/quantization unit 240, a reconstruction unit 250, a loop filter unit 260, a decoded picture buffer 270, and an entropy coding unit 280. The video encoder 200 may include more, fewer, or different functional components. In this disclosure, a current block may be referred to as a current CU, a current PU, or the like. In some examples, a prediction block may also be referred to as a prediction picture block or a picture prediction block, and a reconstructed picture block may also be referred to as a reconstructed block or a picture reconstruction block.

The PU 210 includes an inter PU 211 and an intra PU 212. Due to a strong correlation between adjacent pixels in a picture of a video, in a video coding and decoding technology, spatial redundancy between adjacent pixels is eliminated through an intra prediction method. Due to a strong similarity between adjacent pictures in the video, temporal redundancy between adjacent pictures is eliminated through an inter prediction method, thereby improving encoding efficiency.

The inter PU 211 may be configured to be used in conjunction with inter prediction, and may include motion estimation and motion compensation. Reference may be made to picture information of different frames. During the inter prediction, the motion information is used to find a reference block from a reference frame, and a prediction block is generated based on the reference block, to eliminate the temporal redundancy. The reference frame may be a P-frame and/or a B-frame. The P-frame refers to a forward prediction frame, and the B-frame refers to a bidirectional prediction frame. During the inter prediction, after the motion information is used to find the reference block, the prediction block is generated based on the reference block. The motion information includes a frame list to which the reference frame belongs, a frame index, and a motion vector. The motion vector may be an integer-pixel motion vector or a sub-pixel motion vector. If the motion vector is the sub-pixel motion vector, a required sub-pixel block may be generated through interpolation filtering in the reference frame. A reference block is an integer-pixel or fractional-pixel block found based on the motion vector. In some technologies, the reference block is directly used as the prediction block. In some technologies, the prediction block is generated through further processing based on the reference block. The generating the prediction block through further processing based on the reference block may also be understood as using the reference block as a prediction block and then performing processing based on the prediction block to generate a new prediction block.

The intra PU 212 refers to information of the same picture frame to predict pixel information in a current code picture block, to eliminate the spatial redundancy. The reference frame used for the intra prediction may be an I-frame.

The intra prediction has a plurality of prediction modes. A to-be-coded picture block may be predicted through an angle prediction mode and a non-angle prediction mode, to obtain a prediction block. An optimal prediction mode of the to-be-coded picture block is selected based on rate distortion information obtained through calculation from the prediction block and the to-be-coded picture block, and the prediction mode is written to a bitstream for transmission to a decoder side. The decoder side parses out a prediction mode, obtains a prediction block of a target to-be-decoded block through prediction, and superposes a time-domain residual block obtained based on the bitstream, to obtain a reconstructed block.

An international digital video coding standard H series is used as an example. The H.264/AVC standard has 8 angle prediction modes and 1 non-angle prediction mode and the H.265/HEVC extension to 33 angle prediction modes and 2 non-angle prediction modes. The intra prediction modes used in the HEVC include 35 prediction modes in total, including a planar mode, a direct current (DC) mode, and 33 angle modes. The intra modes used in the VVC include 67 prediction modes in total, including a planar mode, a DC mode, and 65 angle modes. The prediction modes may include a matrix weighted intra prediction (MIP) mode. The prediction modes include a planar mode numbered 0, a DC mode numbered 1, and an angle prediction mode numbered 2 to 66. With an increase in the angle modes, a prediction result of intra prediction is more accurate and better meets requirements for the development of high-definition and ultra-high-definition digital videos. The foregoing intra prediction modes are merely examples of this disclosure, and are not to constitute a limitation on this disclosure.

The residual unit 220 may generate a residual block of the CU based on a pixel block of the CU and a prediction block of the PU of the CU. For example, the residual unit 220 may generate the residual block of the CU, so that each sample in the residual block has a value equal to a difference between a sample in the pixel block of the CU and a corresponding sample in the prediction block of the PU of the CU.

The transform/quantization unit 230 may quantize a transform coefficient. The transform/quantization unit 230 may quantize a transform coefficient associated with the TU of the CU based on a quantization parameter (QP) value associated with the CU. The video encoder 200 may adjust, by adjusting the QP value associated with the CU, a degree of quantization applied to a transform coefficient associated with the CU.

The inverse transform/quantization unit 240 may apply inverse quantization and inverse transform to the quantized transform coefficient to reconstruct the residual block from the quantized transform coefficient.

The reconstruction unit 250 may add samples of the reconstructed residual block to corresponding samples of one or more prediction blocks generated by the PU 210, to generate a reconstructed picture block associated with the TU. In this manner, a sampling block of each TU of the CU is reestablished, and the video encoder 200 may reconstruct a pixel block of the CU.

The loop filter unit 260 is configured to process pixels obtained after inverse transform and inverse quantization to compensate for distorted information, and provide a better reference for subsequent encoded pixels, for example, may perform a deblocking filtering operation to reduce a blocking effect of the pixel block associated with the CU. In some embodiments, the loop filter unit 260 includes a deblocking filter (DBF) unit and a sample adaptive offset/adaptive loop filter (SAO/ALF) unit, where the DBF unit is configured to remove the blocking effect, and the SAO/ALF unit is configured to remove a ringing effect.

The decoded picture buffer 270 may store a reconstructed pixel block. The inter PU 211 may perform inter prediction on a PU of another picture by using a reference picture including the reconstructed pixel block in the decoded picture buffer 270. In addition, the intra PU 212 may perform intra prediction on another PU in the same picture as the CU by using the reconstructed pixel block in the decoded picture buffer 270.

The entropy coding unit 280 may receive the quantized transform coefficient from the transform/quantization unit 230. The entropy coding unit 280 may perform one or more entropy coding operations on the quantized transform coefficient to generate entropy-coded data.

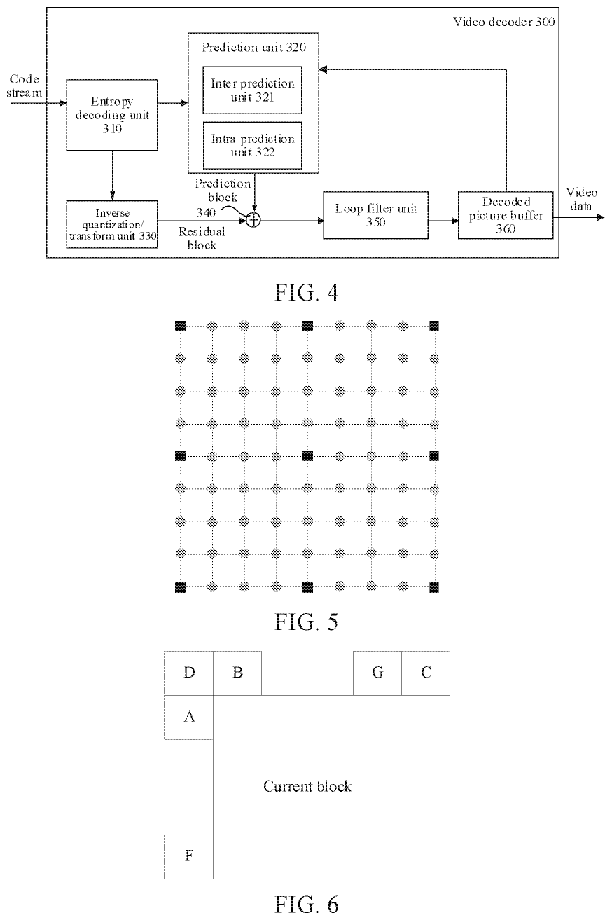

FIG. 4 is a schematic block diagram of a video decoder according to an embodiment of this disclosure.

As shown in FIG. 4, the video decoder 300 includes an entropy decoding unit 310, a PU 320, an inverse quantization/transform unit 330, a reconstruction unit 340, a loop filter unit 350, and a decoded picture buffer 360. The video decoder 300 may include more, fewer, or different functional components.

The entropy decoding unit 310 may parse the bitstream to extract a syntax element from the bitstream. As a portion of parsing the bitstream, the entropy decoding unit 310 may parse an entropy-coded syntax element in the bitstream. The PU 320, the inverse quantization/transform unit 330, the reconstruction unit 340, and the loop filter unit 350 may decode the video data based on the syntax element extracted from the bitstream, to generate decoded video data.

The PU 320 includes an intra PU 322 and an inter PU 321. The intra PU 322 may perform intra prediction to generate a prediction block of a PU. The intra PU 322 may generate the prediction block of the PU based on a pixel block of a spatially adjacent PU by using an intra prediction mode. The intra PU 322 may further determine the intra prediction mode of the PU based on one or more syntax elements parsed from the bitstream. The inter PU 321 may construct a first reference picture list (list 0) and a second reference picture list (list 1) based on the syntax element parsed from the bitstream. In addition, if the PU uses the inter prediction encoding, the entropy decoding unit 310 may parse motion information of the PU. The inter PU 321 may determine one or more reference blocks of the PU based on the motion information of the PU. The inter PU 321 may generate the prediction block of the PU based on one or more reference blocks of the PU.

The inverse quantization/transform unit 330 may perform inverse quantization (i.e., dequantization) on a transform coefficient associated with the TU. The inverse quantization/transform unit 330 may determine a degree of quantization through a QP value associated with the CU of the TU. After the inverse quantization of the transform coefficient, the inverse quantization/transform unit 330 may apply one or more inverse transforms to inverse-quantized transform coefficients to generate a residual block associated with the TU.

The reconstruction unit 340 uses the residual block associated with the TU of the CU and the prediction block of the PU of the CU to reconstruct a pixel block of the CU. For example, the reconstruction unit 340 may add a sample of the residual block to a corresponding sample of the prediction block to reconstruct the pixel block of the CU, thereby obtaining a reconstructed picture block.

The loop filter unit 350 may perform a deblocking filtering operation to reduce a blocking effect of a pixel block associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or transmit the reconstructed picture to a display apparatus for presentation.

With reference to FIG. 2 and FIG. 4, a basic process of video encoding and decoding is as follows.

At an encoder side, a picture frame is divided into picture blocks, and for a current block, the PU 210 predicts a prediction block of the current block (namely, a to-be-encoded block) through intra prediction or inter prediction. The residual unit 220 may calculate a residual block, namely, a difference between the prediction block and the original block, based on the prediction block and the original block of the current block (namely, the to-be-encoded block). The residual block may also be referred to as residual information. The residual block may remove, by the transform/quantization unit 230 through transformation and quantization processes, information that is not sensitive to the human eye, thereby eliminating visual redundancy. In some embodiments, a residual block before the transformation and quantization by the transform/quantization unit 230 may be referred to as a time-domain residual block, and a time-domain residual block after the transformation and quantization by the transform/quantization unit 230 may be referred to as a frequency residual block or a frequency-domain residual block. The entropy coding unit 280 receives a quantized transform coefficient outputted by the transform/quantization unit 230, and may perform entropy coding on the quantized transform coefficient, to output a bitstream. For example, the entropy coding unit 280 may eliminate character redundancy based on a target context model and probability information of a binary bitstream.

At a decoder side, the entropy decoding unit 310 may parse the bitstream to obtain prediction information, a quantization coefficient matrix, and the like of the current block (namely, a to-be-decoded block). The PU 320 predicts a prediction block of the current block (namely, the to-be-decoded block) through intra prediction or inter prediction based on the prediction information. The inverse quantization/transform unit 330 performs inverse quantization and inverse transform on the quantization coefficient matrix by using the quantization coefficient matrix obtained from the bitstream, to obtain a residual block. The reconstruction unit 340 adds the prediction block and the residual block to obtain a reconstructed block. The reconstructed blocks form a reconstructed picture, and the loop filter unit 350 performs loop filtering on the reconstructed picture based on the picture or based on the blocks, to obtain a decoded picture. The encoder side may also use an operation similar to that of the decoder to obtain the decoded picture. The decoded picture may also be referred to as the reconstructed picture, and the reconstructed picture may be a subsequent picture serving as a reference picture for performing inter prediction.

In addition, block division information determined by the encoder, and mode information or parameter information such as prediction, transform, quantization, entropy coding, loop filtering, and the like are carried in the bitstream when necessary. The decoder side determines the same mode information such as block division information, prediction, transformation, quantization, entropy coding, and loop filtering, or parameter information as the encoder side by parsing the bitstream and through analysis based on the available information, thereby the difference between the decoded picture obtained by the encoder and the decoded picture obtained by the decoder may be reduced or eliminated.

Due to a requirement of parallel processing, a picture may be divided into slices and the like, and slices in the same picture may be processed in parallel. For example, no data dependence exists between the slices. A term “frame” may be understood as a picture, a slice, or the like. The foregoing description is a basic process of a video codec in a block-based encoding and decoding framework. With the development of technologies, some modules or operations of the framework or the process may be optimized. To be specific, this disclosure is not limited to the framework and the process.

To facilitate understanding of the technical solutions provided in this disclosure, relevant content is described below.

### (1) Overview of a Video Coding Technology

For a video signal, a signal may be obtained through capturing by a camera or generation by a computer. Due to different statistical characteristics, a corresponding compression coding method may also differ.

For the video coding technology, international video coding standards HEVC, VVC, and the Chinese national video coding standard AVS are used as examples. A hybrid coding framework is used to perform the following operations and processing on an inputted original video signal.

Block partition structure: An inputted picture is partitioned into a plurality of non-overlapping processing units based on a size of a processing unit, and each processing unit is to perform a similar compression operation. The processing unit is referred to as a CTU or an LCU. The CTU may be further divided more finely into obtain one or more basic coding units, which are referred to as CUs. Each CU is the most basic element in an encoding process. Various coding modes that may be used for each CU are described below.

Predictive coding: It includes modes such as intra prediction and inter prediction. After an original video signal is predicted through a selected reconstructed video signal, a residual video signal is obtained. An encoder side selects a most suitable one from numerous possible predictive coding modes for a current CU, and inform a decoder side. Intra prediction: A predicted signal comes from a region that has been encoded and reconstructed in the same picture. Inter prediction: A predicted signal comes from another encoded picture (referred to as a reference picture) that is different from a current picture.

Transform coding and quantization: A residual video signal is transformed into a transform domain through a transform operation such as DFT or DCT, which is referred to as a transform coefficient. A lossy quantization operation is further performed on the signal in the transform domain, which loses a specific amount of information, so that the quantized signal facilitates compression and expression. In some video coding standards, more than one transform mode may be selected. Therefore, the encoder side may also select one of the transform modes for a current to-be-coded CU, and notify the decoder side of the mode. Fineness of quantization may be determined by a quantization parameter (QP). A larger QP indicates that coefficients within a larger value range are to be quantized to the same output, which usually brings larger distortion and a lower bit rate. On the contrary, a smaller QP indicates that coefficients within a smaller value range are to be quantized to the same output, which usually brings less distortion and a higher bit rate.

Entropy coding or statistical coding: Statistical compression coding is performed on the quantized signal in the transform domain based on a frequency of occurrence of each value, and finally a binarized (0 or 1) compressed bitstream is outputted. In addition, entropy coding may also be performed on other information generated during the coding, such as a selected mode and a motion vector, to reduce a bit rate. Statistical coding is a lossless encoding mode that can effectively reduce a bit rate required for expressing the same signal. Common statistical coding modes include variable length coding (VLC) or context adaptive binary arithmetic coding (CABAC).

Loop filtering: Operations such as inverse quantization, inverse transform, and predictive compensation (reverse operations of the foregoing operations 2 to 4) may be performed on an encoded picture to obtain a reconstructed decoded picture. Compared with an original picture, the reconstructed picture has some different information from the original picture due to impact of quantization, resulting in distortion. A filtering operation is performed on the reconstructed picture, for example, through a filter such as a deblocking filter, an SAO filter, or an ALF, which can reduce a degree of distortion caused by quantization. Since the filtered reconstructed picture is used as a reference for subsequently encoding a picture to predict a future signal, the filtering operation is also referred to as loop filtering, namely, a filtering operation in a coding loop.

It may be seen from the foregoing encoding process that at the decoder side, for each CU, after a decoder obtains a compressed bitstream, entropy decoding is first performed to obtain various mode information and quantized transform coefficients. Inverse quantization and inverse transform are performed on the coefficients to obtain a residual signal. Moreover, a predicted signal corresponding to the CU can be obtained according to coding mode information that is known. Then the residual video signal may be added to the predicted signal to obtain a reconstructed signal. Finally, a loop filtering operation may be performed on the reconstructed value of the decoded picture, to generate a final output signal.

### (2) Common Inter Prediction Mode and Intra Block Copy Mode

Prediction pixels in inter prediction or intra block copy mode are obtained by searching a reconstructed region of a reconstructed reference frame or a current frame, or by searching a sub-pixel interpolation picture thereof. For a chrominance component, it may be considered that the chrominance component has a similar motion vector or block vector to the luminance component by default. Therefore, the motion vector or the block vector of the chrominance is simply deduced based on a motion vector or a block vector of luminance. Because during the matching search, not only a matching degree of a picture may be considered, but also an encoding cost of a motion vector or a block vector may be considered, the matching search is not necessarily optimal in the dimension of the matching degree. For example, there is still a specified room for improvement in prediction accuracy.

### (3) Unidirectional Motion Information and Bidirectional Motion Information

In an inter encoding mode, reference frames in time domain may be classified into a forward reference frame and a backward reference frame based on time-domain positions of the reference frames relative to the current frame. The motion information may include a reference frame index and a motion vector (MV). If one piece of motion information includes one piece of motion information, the motion information is referred to as unidirectional motion information; and if one piece of motion information includes 2 pieces of motion information, the motion information is referred to as bidirectional motion information. The bidirectional motion information does not mean that forward motion information and backward motion information exist, or only the forward motion information may exist. Similarly, for the intra block copy mode, because the search region may be in the current frame, the motion information of the intra block copy mode may not have a reference frame index.

### (4) Integer Pixel and Fractional Pixel

FIG. 5 is an example of an integer pixel and a fractional pixel according to an embodiment of this disclosure.

As shown in FIG. 5, black squares represent integer pixels (a resolution of all integer pixels in a frame equals a video resolution). However, motion of objects or changes in texture are often not necessarily at integer-pixel precision. Therefore, the associated motion vector may also be non-integer pixels and may point to a ¼ fractional-pixel position indicated by a gray circle in the FIG.

### (5) Motion Vector Prediction (MVP)

Time-domain motion vector prediction (TMVP): It means that a motion vector comes from a reference frame. For example, a to-be-encoded block MV at a position corresponding to the current block (a sub-block inside the block or a sub-block outside the block) on a time-domain reference frame may be selected as the motion vector prediction of the current block (after being directly or simply offset).

Space-domain motion vector prediction (SMVP): It means that a motion vector comes from a current frame (an encoded/decoded region). For example, the MV of the to-be-encoded block in the encoded region adjacent to the current block may be selected as motion vector prediction of the current block (after being directly or simply offset). For example, in AVS3, as shown in FIG. 6, the sub-blocks F, G, C, A, B, and D outside the block are searched for a piece of bidirectional, backward, and forward motion information, and the information is added to a motion vector prediction list.

History-based motion vector prediction (HMVP): HMVP is motion vector prediction based on historical information. In the HMVP technology, 8 pieces of motion information candidates are copied from previously encoded blocks into a FIFO, and the FIFO is continuously updated in a first-in first-out manner. If a motion information candidate in the FIFO is the same as motion information that has just been encoded, the duplicate candidate is first removed, and the motion information of the current CU is added to the tail of the FIFO. If motion information of the current CU is different from all motion information candidates in the FIFO, a first candidate in the FIFO is removed, and latest motion information is added to the end of the FIFO, to retain 8 latest motion candidates in the FIFO.

### (6) Motion Search Method

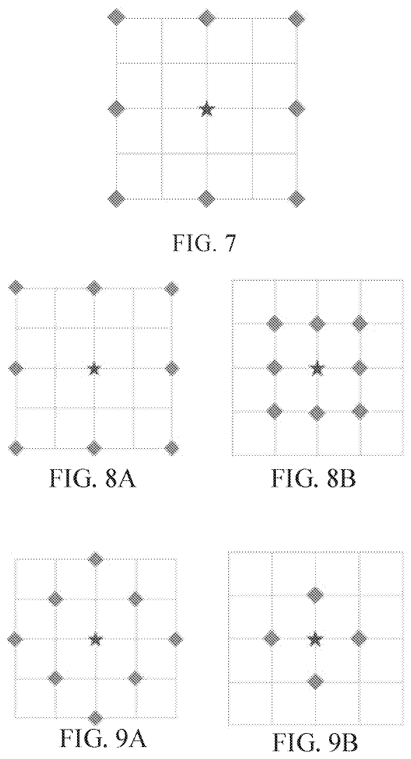

Three-step search method: A search is performed by using a search pattern shown in FIG. 7. A search step size is halved each time, and three iterative searches are performed. In each iterative search, a search point with a minimum SAD is selected as a starting point for a next iterative search.

Four-step search method: A search is performed by using a search pattern shown in FIG. 8A. First, a 5×5 picture is searched, and an iterative search is performed until the center is optimal. Then the searched picture is scaled to a search pattern shown in FIG. 8B, and one more search is performed to obtain an optimal search point.

Diamond search method: A search is performed by using a search pattern shown in FIG. 9A. An iterative search is performed until the center is optimal. Then the search continues to be performed by using a search pattern shown in FIG. 9B, and one more search is performed to obtain an optimal search point.

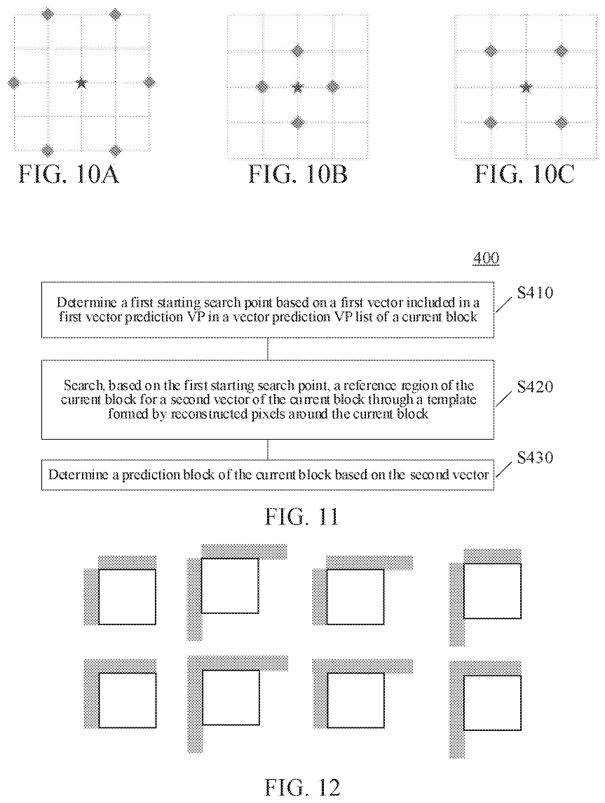

Hexagon search method: A search is performed by using a search pattern shown in FIG. 10A. An iterative search is performed until the center is optimal. Then one search continues to be performed by using a search pattern shown in FIG. 10B, and one more search is performed by using a search pattern shown in FIG. 10C, to obtain an optimal search point.

The following describes a template matching-based prediction method according to an embodiment of this disclosure with reference to the accompanying drawings. The prediction method may be applied to a product having a relevant video codec or video compression. For example, the prediction method provided in this embodiment of this disclosure may be performed by an encoder side, for example, the encoding device 110 or the video encoder 112 shown in FIG. 1, and the video encoder 200 shown in FIG. 2. For another example, the prediction method provided in this embodiment of this disclosure may be performed by a decoder side, for example, the decoding device 120 or the video decoder 122 shown in FIG. 1, and the video decoder 300 shown in FIG. 4. For ease of description, the prediction method is described below by using a prediction apparatus as an example.

FIG. 11 is a schematic flowchart of a template matching-based prediction method 400 according to an embodiment of this disclosure.

As shown in FIG. 11, the prediction method 400 may include at least some of the following content.

S410: The prediction apparatus determines a first starting search point based on a first vector included in a first vector prediction entry (or simply referred to as a VP) in a vector prediction (VP) list of a current block. For example, a first starting search point in a first reference picture is determined based on a first vector included in a first vector prediction list of a current block in a current picture.

For example, the VP list includes, but is not limited to, a motion vector prediction (MVP) list or a block vector prediction (BVP) list. When the VP list includes the MVP list, the first VP is a first MVP, and the first vector is an MV. When the VP list includes the BVP list, the first VP is a BVP, and the first vector is a BV.

S420: The prediction apparatus searches, based on the first starting search point, a reference region of the current block for a second vector of the current block through a template formed by reconstructed pixels adjacent to the current block. For example, based on the first starting search point, a first reference region of the current block is searched for a second vector through a template of reconstructed pixels adjacent to the current block.

Moreover, in some examples, a second starting search point in a second reference picture is determined based on a third vector included in the first vector prediction list or a second vector prediction list of the current block different from the first vector prediction list. In some examples, based on the second starting search point, a second reference region of the current block is searched for a fourth vector through the template of reconstructed pixels adjacent to the current block.

For example, the template of the current block may include the reconstructed pixels adjacent to the current block, and the reconstructed pixels adjacent to the current block include reconstructed pixels in at least one of the following positions adjacent to the current block: left, top, upper left, lower left, or upper right. For example, FIG. 12 provides an example of 8 templates formed by reconstructed pixels around a current block. This disclosure is not limited to the template example provided in FIG. 12.

For example, the reference region of the current block is related to a prediction mode of the current block. For example, the prediction mode of the current block may be an inter prediction mode or an intra block copy mode. When the prediction mode of the current block is the inter prediction mode, the reference region is located in a reference frame of the current block; and when the prediction mode of the current block is the intra block copy mode, the reference region is in a reconstructed region of a current picture to which the current block belongs. The reference region may also be referred to as a search region.

For example, the prediction apparatus searches the reference region of the current block for the second vector of the current block through a cost of the template of the current block relative to a template of each candidate search point based on the first starting search point. For example, the prediction apparatus searches, based on the first starting search point, at least one candidate search point in the reference region of the current block for the second vector of the current block through a cost of a template formed by reconstructed pixels adjacent to the current block relative to a template of each candidate search point.

The template of the candidate search point involved in this disclosure may be understood as a template matched based on the candidate search point or a template found based on the candidate search point during template matching. A specific description manner of the template is not limited in this disclosure.

S430: The prediction apparatus determines a prediction block of the current block based on the second vector. For example, a prediction block of the current block is obtained based on fusing a first prediction block indicated by the second vector and a second prediction block indicated by the fourth vector. In some examples, the current block is reconstructed based on the prediction block. In some other examples, the current block is encoded into a bitstream based on the prediction block.

For example, the prediction apparatus determines the prediction block of the current block based on a first prediction block to which the second vector points.

In this embodiment, the template matching-based prediction method includes: determining a first starting search point based on a first vector included in a first vector prediction entry (e.g., first VP) in a vector prediction (VP) list of a current block; searching a reference region of the current block for a second vector of the current block through a template formed by reconstructed pixels adjacent to the current block based on the first starting search point; and determining a prediction block of the current block based on the second vector. For example, through the template matching-based prediction method, the reference region of the current block may be searched for the second vector of the current block through the template constructed by the reconstructed pixels adjacent to the current block based on the first starting search point, and then the prediction block of the current block is determined based on the second vector. An encoder side and a decoder side may both determine the prediction block of the current block by using the template matching-based prediction method, namely, the encoder side may not need to transfer vector information to the decoder side, so that a bit rate occupied during transfer of the motion information can be saved, thereby increasing transmission efficiency.

In addition, a second vector is obtained by searching based on the first starting search point, and then the prediction block of the current block is determined based on the second vector. This approach may help obtain a prediction block with improved quality, which can contribute to improving a prediction effect of the current block.

In some embodiments, the first VP is indicated through a first identifier, the first identifier being carried in a bitstream or determined through derivation by a decoder side, or the first VP is a VP having a minimum template cost in the VP list.

In this disclosure, the identifier (for example, the first identifier or another identifier) is determined through derivation by the decoder side, which is intended to describe that both the encoder side and the decoder side can determine the identifier through derivation. Alternatively, the encoder side does not need to write the identifier into the bitstream, and the decoder side does not need to obtain the identifier by decoding the bitstream. A specific derivation process therefor is not limited in this disclosure. That the identifier is determined through derivation by the decoder side may also be equivalently replaced by that the identifier is determined through implicit indication, or the identifier is determined through implicit derivation. The identifier is carried in the bitstream, which means that the decoder side writes the identifier into the bitstream, and the decoder side obtains the identifier by decoding the bitstream.

The first VP may be a VP having a minimum template cost in the VP list, or may be another VP in the VP list. Examples described above are non-limiting examples and are not intended to limit the scope of this disclosure. For example, in some other embodiments, the first VP may be a VP determined from the VP list based on the size of the current block or other information.

In some other embodiments, the search for the second vector in this disclosure may alternatively be equivalently replaced with a search for the first prediction block to which the second vector points, or may be equivalently replaced with a search for the template of the first prediction block to which the second vector points. Examples described above are non-limiting examples and are not intended to limit the scope of this disclosure. For example, the search for the first prediction block to which the second vector points is used as an example. The prediction apparatus may determine the first starting search point based on the first vector included in the first VP in the VP list of the current block; search the reference region of the current block for the first prediction block through a template formed by reconstructed pixels adjacent to the current block based on the first starting search point; and determine a prediction block of the current block based on the first prediction block.

In some embodiments, when the first identifier is carried in the bitstream, a codeword length of the first identifier is positively correlated with a template cost of the first VP.

For example, when serving as an encoder side, the prediction apparatus may perform template cost evaluation on VPs in the VP list, and then order the VPs in the VP list in ascending order of template costs, so that a codeword length corresponding to a VP having a minimum template cost is the minimum. For example, assuming that 4 VPs exist in the VP list, when the first identifier indicates the 4 VPs in the VP list in ascending order of the template costs, codewords corresponding to the VPs may be successively 1, 01, 001, and 000.

In some other embodiments, the codeword length of the first identifier may also have no relationship with the template cost of the first VP. For example, the codeword length of the first identifier is determined based on a quantity of VPs in the VP list, or is a fixed length.

In some embodiments, before S410, the method 400 further includes:

constructing an initial list based on at least one of an adjacent space-domain VP, a time-domain VP, a non-adjacent space-domain VP, a history-based VP, an average VP, or a zero-vector VP; and performing at least one of deduplication, vector adjustment, template cost evaluation, or template cost-based ordering on initial VPs in the initial list, to obtain the VP list.

For example, the adjacent space-domain VP refers to predicting the vector of the current block based on a vector of a spatially adjacent decoded block of the current block. Due to continuity in a video sequence, a vector of an adjacent block is often similar to the vector of the current block. The time-domain VP refers to predicting the vector of the current block by using a vector of a corresponding position block in a decoded reference picture. This helps capture motion consistency across a plurality of frames. The non-adjacent space-domain VP is similar to an adjacent space-domain VP, but considers farther or less direct neighboring blocks. The blocks may be located on the same row or column of the current block, or may be determined based on a search pattern. The history-based VP refers to predicting the vector of the current block by using a vector of a decoded block (which may be located in a different frame or a different CU). Through this method, a motion mode or a periodic motion with a relatively large time span may be captured. The average VP refers to averaging vectors of a plurality of decoded blocks (which may be adjacent or non-adjacent) to obtain a predicted vector. This method helps to smooth a change in a motion vector and reduce a prediction error. The zero-vector VP refers to using, for a small motion or stationary block, a zero-vector as a predicted vector. This helps reduce a quantity of bits required for encoding the small motion or stationary block.

For example, an adjacent space-domain MVP, a time-domain MVP, a non-adjacent space-domain MVP, a history-based MVP, an average MVP, and a zero-vector MVP are used examples. The adjacent space-domain MVP refers to predicting a motion vector of the current block based on a motion vector of a spatially adjacent decoded block of the current block. Due to continuity in a video sequence, a motion vector of an adjacent block is often similar to the motion vector of the current block. The time-domain MVP refers to predicting the motion vector of the current block by using a motion vector of a corresponding position block in a decoded reference picture. This helps capture motion consistency across a plurality of frames. The non-adjacent space-domain MVP is similar to an adjacent space-domain MVP, but considers farther or less direct neighboring blocks. The blocks may be located on the same row or column of the current block, or may be determined based on a search pattern. The history-based MVP refers to predicting the motion vector of the current block by using a motion vector of a decoded block (which may be located in a different frame or a different CU). Through this method, a motion mode or a periodic motion with a relatively large time span may be captured. The average MVP refers to averaging motion vectors of a plurality of decoded blocks (which may be adjacent or non-adjacent) to obtain a predicted motion vector. This method helps to smooth a change in a motion vector and reduce a prediction error. The zero-vector MVP refers to using, for a small motion or stationary block, a zero-vector as a predicted motion vector. This helps reduce a quantity of bits required for encoding the small motion or stationary block.

For a construction process of the initial list in this disclosure, reference may be made to a construction process of the MVP list or a construction process of the BVP list.

The construction process of the MVP list is used as an example. The initial list may be constructed through a construction process of an MVP list of a merge/skip/direct mode/an advanced motion vector prediction (AMVP) mode of an inter prediction mode. For example, the initial list may be constructed based on an encoded and decoded block (namely, a space-domain MVP) adjacent to the current block, an encoded and decoded block in a time-domain-associated position (namely, a time-domain MVP), a history-based MVP (HMVP), and a zero-vector MVP. For another example, an MV in a time domain may be selected to construct two pieces of unidirectional motion information (respectively pointing to a forward reference frame list and a backward reference frame list) to form one MVP, to construct the initial list.

For example, similar to an MVP list construction manner in a direct or skip mode, an MVP list having a length of 4 is constructed, which successively includes a time-domain MVP, a bidirectional MVP constructed by adjacent space-domain MVPs, a backward MVP, and a forward MVP.

For example, the prediction apparatus may perform deduplication processing on the initial VPs in the initial list, namely, deleting duplicate initial VPs in the initial list.

For example, the prediction apparatus may perform vector adjustment on the initial VPs in the initial list. For example, the prediction apparatus may adjust a position to which the initial VPs in the initial list point. For another example, the prediction apparatus may adjust at least one dimension of vectors of the initial VPs in the initial list.

For example, the prediction apparatus may perform template cost evaluation on the initial VPs in the initial list.

For example, the prediction apparatus may perform template cost-based ordering on the initial VPs in the initial list. For example, the prediction apparatus may perform template cost evaluation on the initial VPs in the initial list, and then perform template cost-based ordering on the initial VPs in the initial list.

When the prediction apparatus performs at least one of deduplication, vector adjustment, template cost evaluation, or template cost-based ordering on the initial VPs in the initial list, sequences of the deduplication, the vector adjustment, the template cost evaluation, and the template cost-based ordering may be flexibly adjusted. An example in which the prediction apparatus performs deduplication, vector adjustment, and template cost evaluation on the initial VPs in the initial list is used. An execution order may be deduplication, template cost evaluation, and vector adjustment, or may be template cost evaluation, vector adjustment, deduplication, or the like, or may be deduplication, vector adjustment, and template cost evaluation.

In some embodiments, S410 includes:

determining, as the first starting search point, a position to which the first vector points; or

adjusting the first vector along at least one dimension to obtain an adjusted vector of the first vector, and determining, as the first starting search point, a position to which the adjusted vector points.

For example, the at least one dimension corresponds to at least one value of the first vector. For example, the prediction apparatus may adjust at least one value of the first vector to obtain an adjusted vector of the first vector, and determine, as the first starting search point, a position to which the adjusted vector points. In some embodiments, the at least one dimension may be determined through agreement in a protocol, being carried in the bitstream, or derivation by the decoder side.

In some embodiments, the adjusting the first vector along at least one dimension to obtain an adjusted vector of the first vector includes at least one of the following:

adjusting the first vector along the at least one dimension based on a vector difference VD of the first vector, to obtain the adjusted vector;

determining a quantity of shift bits based on the first vector, performing right shift calculation on the first vector along the at least one dimension based on the quantity of shift bits, and performing left shift calculation on a calculation result obtained after a right shift based on the quantity of shift bits, to obtain the adjusted vector;

adjusting the first vector along the at least one dimension to point to an integer-pixel position closest to the position to which the first vector points, to obtain the adjusted vector; or

offsetting the first vector along the at least one dimension based on a preset offset, to obtain the adjusted vector.

For example, when the first vector is an MV, a VD of the first vector is a motion vector difference (MVD). Similarly, when the first vector is a BV, a VD of the first vector is a block vector difference (BVD). For example, when the first vector is an MV in an AMVP mode, the VD of the first vector is an MVD, namely, the prediction apparatus may perform template matching based on (MV+MVD) to obtain a better MV (namely, the second vector). The MVD is obtained by parsing the bitstream. For another example, when the first vector is an MV in an IBC mode, the VD of the first vector is a BVD, namely, the prediction apparatus may perform template matching based on (BV+BVD) to obtain a better BV (namely, the second vector). The BVD is obtained by parsing the bitstream.

For example, the prediction apparatus may determine a quantity of shift bits based on the first vector, perform right shift calculation on the first vector along the at least one dimension based on the quantity of shift bits, and perform left shift calculation on a calculation result obtained after a right shift based on the quantity of shift bits, to obtain the adjusted vector. In this embodiment, the prediction apparatus may directly clear values of fractional pixels of the first vector, so that the first vector is an integer-pixel value. In some embodiments, the prediction apparatus may determine a quantity of bits corresponding to precision of the first vector as the quantity of shift bits. For example, an example in which the first vector is (MV_x, MV_y) is used. If the precision of the first vector is ¼ pixel, the prediction apparatus may perform a shift operation on the first vector along each dimension in the following manner, to obtain the adjusted vector:

(MV_x>>2)<<2, (MV_y>>2)<<2.

For example, the prediction apparatus may adjust the first vector along the at least one dimension to point to an integer-pixel position closest to the position to which the first vector points, to obtain the adjusted vector. For example, the position to which the first vector points may also be referred to as an original pointing position. To be specific, the prediction apparatus may adjust the first vector along at least one dimension to point to an integer pixel closest to the original pointing position. In some other embodiments, the prediction apparatus may adjust the first vector along the at least one dimension to point to another fractional-pixel position closest to the position to which the first vector points, to obtain the adjusted vector. Examples described above are non-limiting examples and are not intended to limit the scope of this disclosure.

For example, the prediction apparatus may offset the first vector along the at least one dimension based on a preset offset, to obtain the adjusted vector. For example, an example in which the first vector is (MV_x, MV_y) is used. The prediction apparatus may offset MV_x and MV_y by ¼, ½, or ¾ pixel separately, to obtain the adjusted vector.

For example, the prediction apparatus may determine a quantity of shift bits based on the first vector, perform right shift calculation on the first vector along the at least one dimension based on the quantity of shift bits, and perform left shift calculation on a calculation result obtained after a right shift based on the quantity of shift bits, and the prediction apparatus may offset the first vector along a second dimension based on a preset offset, to obtain the adjusted vector. For example, when the first dimension is a fractional-pixel value and the second dimension is an integer-pixel value, the prediction apparatus may determine a quantity of shift bits based on the first vector, perform right shift calculation on the first vector along the at least one dimension based on the quantity of shift bits, and perform left shift calculation on a calculation result obtained after a right shift based on the quantity of shift bits, and the prediction apparatus may offset the first vector along a second dimension based on a preset offset, to obtain the adjusted vector. For example, for the first vector (MV_x, MV_y) with ¼-pixel precision, if one dimension is an integer-pixel value, +2 or −2 is adjusted to a ½-pixel position; and if the other dimension is a fractional pixel, a right shift by 2 bits is first performed, and then a left shift by 2 bits is performed, to obtain an adjusted vector.

For example, the prediction apparatus may adjust the first vector along the at least one dimension to point to an integer-pixel position, and then adjust the at least one dimension to point to a fractional-pixel position. For example, the prediction apparatus may determine a quantity of shift bits based on the first vector, perform right shift calculation on the first vector along the at least one dimension based on the quantity of shift bits, and perform left shift calculation on a calculation result obtained after a right shift based on the quantity of shift bits, and then may offset at least one dimension of a left-shifted vector based on a preset offset, to obtain the adjusted vector. For another example, the prediction apparatus may adjust the first vector along the at least one dimension to point to an integer-pixel position closest to the position to which the first vector points, and then may offset, based on a preset offset, at least one dimension of a vector pointing to the integer-pixel position closest to the position to which the first vector points, to obtain the adjusted vector.

In this disclosure, the adjusting the first vector along one or more dimensions may be understood as adjusting a value of the first vector in a dimension. In some examples, the adjusting the first vector along one or more dimensions may be understood as adjusting a specific dimension. In addition, in some other embodiments, the prediction apparatus may offset the first vector along at least one dimension according to a preset rule, to obtain the adjusted vector. Examples described above are non-limiting examples and are not intended to limit the scope of this disclosure.

In some embodiments, S420 includes:

searching for at least one candidate search point based on the first starting search point; and

adjusting the first vector to point to a first optimal search point having a minimum template cost in the at least one candidate search point, to obtain the second vector.

For example, when the first candidate search point is the first optimal search point, the prediction apparatus may directly determine the first vector as the second vector. When the first candidate search point is not the first optimal search point, the prediction apparatus adjusts the first vector to point to the first optimal search point, to obtain the second vector.

In some embodiments, the searching for at least one candidate search point based on the first starting search point includes at least one of the following:

obtaining the at least one candidate search point through traversal search of candidate search points; or

performing, based on the first starting search point and a first search shape used by the current block, an iterative search on a candidate search point having a minimum template cost, to obtain candidate search points obtained in a current iteration process, and determining, as the first optimal search point, a candidate search point having the minimum template cost that is obtained in the current iteration process until a preset condition is satisfied.

The preset condition includes at least one of the following:

the candidate search point having the minimum template cost that is obtained in the current iteration process is a starting search point used in the current iteration process;

a quantity of iterations that have been performed is greater than or equal to a maximum quantity of iterations; or

a quantity of points that have been searched is greater than or equal to a maximum quantity of search points.

For example, that the quantity of points that have been searched is greater than or equal to the maximum quantity of search points may be understood as that, for example, a quantity of points that have been searched and subjected to deduplication is greater than or equal to the maximum quantity of search points, and for another example, the quantity of points that have been searched and that include duplicated points is greater than or equal to the maximum quantity of search points.

For example, the prediction apparatus may obtain the at least one candidate search point by traversing all candidate search points in the reference region.

For example, in a search method for the prediction apparatus to obtain the at least one candidate search point through traversal search of the candidate search points, the prediction apparatus may traverse all possible candidate search points in the reference region to search for a first optimal search point having the minimum template cost.

For example, the prediction apparatus may perform, based on the first starting search point and a first search shape, an iterative search on a candidate search point having a minimum template cost in the reference region, to obtain candidate search points obtained in a current iteration process, and determine, as the first optimal search point, a candidate search point having the minimum template cost that is obtained in the current iteration process until a preset condition is satisfied. When the prediction apparatus performs the iterative search, the at least one candidate search point includes a candidate search point obtained in each iteration process. The candidate search points obtained in different iteration processes may not overlap, or may partially overlap. Examples described above are non-limiting examples and are not intended to limit the scope of this disclosure.

For example, after obtaining the at least one candidate search point through traversal search of the candidate search points, the prediction apparatus may perform template cost evaluation on the at least one candidate search point, and adjust the first vector to point to a first optimal search point having a minimum template cost in the at least one candidate search point, to obtain the second vector.

For example, after performing the iterative search on the candidate search point having the minimum template cost to obtain the candidate search point obtained in the current iteration process, the prediction apparatus may perform deduplication on the candidate search points obtained in the current iteration process, for example, remove a candidate search point that has been excluded previously, then perform template cost evaluation on the candidate search points after being subjected to deduplication, and adjust the first vector to point to the first optimal search point having the minimum template cost in the candidate search points that are subjected to deduplication, to obtain the second vector.

For example, when the prediction apparatus performs template cost evaluation, as shown in FIG. 13, in each search, the template of the candidate search point is obtained, and a difference between the template and the template of the current block is calculated. The difference is determined by using a sum of absolute differences (SAD), a sum of squared differences (SSD), a mean of absolute differences (MAD), a mean of squared differences (MSD), or the like. An objective is to find, as quickly as possible, a candidate search point having a minimum difference between the template and the template of the current block in the reference region, and determine the prediction block of the current block based on the candidate search point.

In this embodiment, a cutoff condition for the prediction apparatus to perform the iterative search includes at least one of the following:

the candidate search point having the minimum template cost that is obtained in the current iteration process is a starting search point used in the current iteration process;

a quantity of iterations that have been performed is greater than or equal to a maximum quantity of iterations; or

a quantity of points that have been searched is greater than or equal to a maximum quantity of search points.

The foregoing cutoff condition may be used separately, or may be used in combination.

For example, the prediction apparatus may perform, based on the first starting search point and a first search shape used by the current block, an iterative search on a candidate search point having a minimum template cost, to obtain candidate search points obtained in a current iteration process, and determine, as the first optimal search point, a candidate search point having the minimum template cost that is obtained in the current iteration process until the candidate search point having the minimum template cost that is obtained in the current iteration process is the starting search point used in the current iteration process.

For another example, the prediction apparatus may perform, based on the first starting search point and a first search shape used by the current block, an iterative search on a candidate search point having a minimum template cost, to obtain candidate search points obtained in a current iteration process, and determine, as the first optimal search point, a candidate search point having the minimum template cost that is obtained in the current iteration process until any one of the following conditions is satisfied.

The candidate search point having the minimum template cost that is obtained in the current iteration process is a starting search point used in the current iteration process;

a quantity of iterations that have been performed is greater than or equal to a maximum quantity of iterations; or

a quantity of points that have been searched is greater than or equal to a maximum quantity of search points.

In some embodiments, the performing, based on the first starting search point and a first search shape used by the current block, an iterative search on a candidate search point having a minimum template cost, to obtain candidate search points obtained in a current iteration process includes:

performing, based on the first starting search point and a search method used by the current block, the iterative search on the candidate search point having the minimum template cost, to obtain candidate search points obtained in the current iteration process, the search method including at least one search shape and a quantity of iterations corresponding to each of the at least one search shape, the at least one search shape including the first search shape.

For example, that the prediction apparatus performs the iterative search on the candidate search point having the minimum template cost is equivalent to striking a balance between a search speed and searching for an optimal template prediction block. A template matching algorithm is similar to a motion search method at an encoder side. For example, common methods include a three-step search method, a four-step search method, a diamond search method, a hexagon-based search method, and an asymmetrical cross multi-level hexagon grid search method.

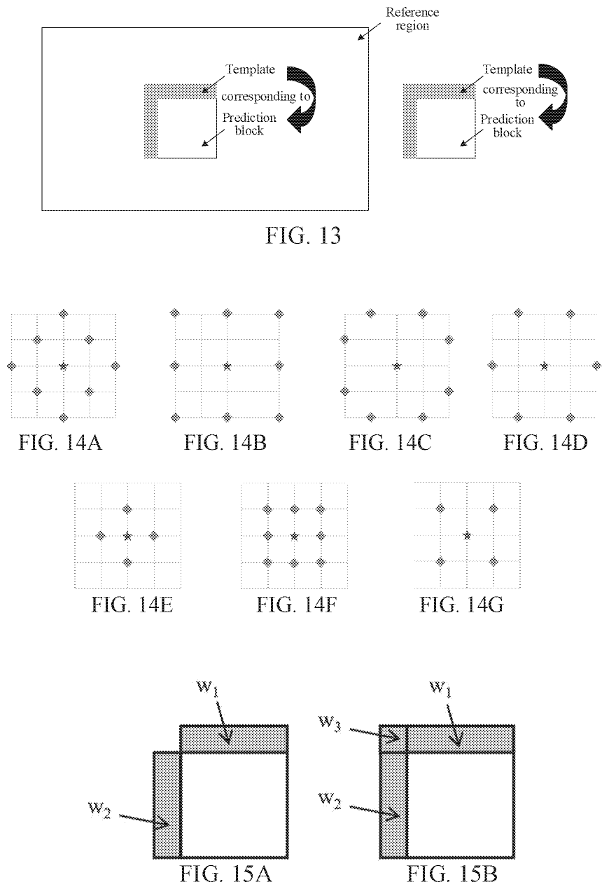

FIGS. 14A-14G are examples of search shapes included in a search method according to an embodiment of this disclosure.

In some examples, a search shape included in the search method may be one or more of the shapes FIGS. 14A-14G. A five-pointed star in each shape represents a starting search point used in one iteration process, and the five-pointed star and all squares constitute candidate search points that need to be searched in the iteration process. Template costs of found candidate search points are compared to obtain a candidate search point having a minimum template cost, which is referred to as one iteration process. A current iteration process in this disclosure may be understood as a current (or current round of) iteration process or an iteration process that is currently performed.

When performing the iterative search on the candidate search point having the minimum template cost, the prediction apparatus may search for the candidate search point having the minimum template cost through a plurality of iteration processes.

In an example, after obtaining the candidate search point having the minimum template cost in the current iteration process, the prediction apparatus determines, as the first optimal search point, the candidate search point having the minimum template cost that is obtained in the current iteration process when the preset condition is satisfied. When the preset condition is not satisfied, the iteration process is performed again, namely, the obtained candidate search point having the minimum template cost (namely, the candidate search point having the minimum template cost that is obtained in a most recent iteration process) is used as a starting search point (namely, a position of the five-pointed star) used in the current iteration process. The candidate search point having the minimum template cost is searched to obtain the candidate search point having the minimum template cost in the current iteration process, and so on, until the candidate search point having the minimum template cost that is obtained in the current iteration process is determined as the final optimal search point (namely, the first optimal search point) when the preset condition is satisfied. The preset condition may be that the starting search point (namely, the position of the five-pointed star) used in the current iteration process is the candidate search point having the minimum template cost, or the preset condition may also be using (or combined with) a maximum quantity of iterations/a maximum quantity of search points that is N (a positive integer).

A position spacing of search points in the figure is merely an example, and may be scaled proportionally.

In an implementation, the same search shape may be used in different iteration processes of the entire search process.

Although the same search shape is used, a spacing (which may also be referred to as a search step size) between the candidate search points may be scaled. For example, with an increase in a quantity of iterations, after at least 1 iterative search is performed, the spacing between the candidate search points may be scaled down. For example, the three-step search method shown in FIG. 7 is used.

In another implementation, different search shapes may be combined to form an entire search method similar to the search method used during motion estimation of the encoder side. 3 examples of actual search are listed:

Example 1: An iterative search is first performed by using a large rhombus shown in FIG. 14A, a maximum quantity of iterations is limited to 30, and after the search is terminated, one search is performed by using a small rhombus shown in FIG. 14E.

Example 2: A search is first performed by using a hexagon shown in FIG. 14D, a maximum quantity of iterations is limited to 30, then one search is performed by using the small rhombus shown in FIG. 14E, and one search is performed by using a square shown in FIG. 14G.

Example 3: A search is first performed by using the hexagon shown in FIG. 14D, a maximum quantity of iterations is limited to 40, and then one search is performed by using a square shown in FIG. 14F.

In this embodiment, the search method used by the current block may be referred to as a template matching-based search method. The template matching-based search method may be the same as or different from a search method used during motion estimation at the encoder side. Examples described above are non-limiting examples and are not intended to limit the scope of this disclosure.

In some embodiments, the performing, based on the first starting search point and a first search shape used by the current block, an iterative search on a candidate search point having a minimum template cost, to obtain candidate search points obtained in a current iteration process includes:

performing, based on the first starting search point and the first search shape, a first iteration process on the candidate search point having the minimum template cost, to obtain candidate search points obtained in the first iteration process, and performing, based on the candidate search point having the minimum template cost in the candidate search points obtained in the first iteration process, a second iteration process on the candidate search point having the minimum template cost, to obtain candidate search points obtained in the second iteration process;

determining, when a first candidate search point obtained in the first iteration process overlaps with a second candidate search point obtained in the second iteration process, a template cost of the first candidate search point as a template cost of the second candidate search point; or

ignoring the second candidate search point when the first candidate search point overlaps with the second candidate search point and the second candidate search point is not the starting search point used in the second iteration process, or determining, based on candidate search points obtained in the second iteration process other than the second candidate search point, the candidate search point having the minimum template cost in the second iteration process.

For example, in different iterative search processes, if an overlapping candidate search point exists, a previous template cost may be loaded and does not need to be recalculated, to reduce complexity. Alternatively, if the overlapping candidate search point is not a starting search point used in the current iteration process (for example, the position of the five-pointed star in one or more of the search shapes shown in FIGS. 14A-14G), cost calculation of the overlapping candidate search point may be directly discarded (the search point is less likely to be optimal because the search point was not selected before), to reduce search complexity.

In some embodiments, an absolute value of a first offset of any candidate search point in at least one candidate search point is less than or equal to a third preset threshold, or an absolute value of a second offset of any candidate search point is less than or equal to a fourth preset threshold, or a sum of the absolute value of the first offset and the absolute value of the second offset of any candidate search point is less than or equal to a fifth preset threshold. The first offset is an offset of any candidate search point relative to the first starting search point in a first dimension, and the second offset is an offset of any candidate search point relative to the first starting search point in a second dimension.

For example, the first dimension is a horizontal direction, and the second dimension is a vertical direction.

For example, an example in which the position of the first starting search point is (MV0_x, MV0_y) is used. Absolute values (|MV_x-MV0_x|, |MV_y-MV0_y|) of offsets of any candidate search point relative to the first starting search point in the horizontal direction and the vertical direction are respectively not greater than M (a positive integer) and N (a positive integer). For example, M and N are respectively 8 integer pixels.

For example, an example in which the position of the first starting search point is (MV0_x, MV0_y) is used. A sum of absolute values (|MV_x-MV0_x|+|MV_y-MV0_y|) of offsets of any candidate search point relative to the first starting search point in the horizontal direction and the vertical direction does not exceed M (a positive integer). For example, M is set to 10 integer pixels.

In this disclosure, during a search of the at least one candidate search point, a search range may not be limited, or may be limited. When the search range is limited, a search process may be restricted to be performed within the limited search range, which can reduce complexity and hardware implementation cost.

In some embodiments, before obtaining the second vector, the method 400 further includes:

determining cost weights of a plurality of template regions based on the plurality of template regions of the current block; and weighting template costs of the plurality of template regions relative to any candidate search point in the at least one candidate search point based on the cost weights of the plurality of template regions, to obtain a template cost of any candidate search point. A cost weight of a first template region in the plurality of template regions satisfies at least one of the following:

the cost weight of the first template region is positively correlated with a first size, the first size being a size of a length of a side of the current block adjacent to the first template region; or

the cost weight of the first template region is negatively correlated with a first distance, the first distance being a distance between the first template region and the current block.

For example, the prediction apparatus determines cost weights of a plurality of template regions based on the plurality of template regions of the current block; and weighting template costs of the plurality of template regions relative to any candidate search point in the at least one candidate search point based on the cost weights of the plurality of template regions, to obtain a template cost of any candidate search point. The cost weight of the first template region is positively correlated with the first size.

FIGS. 15A-15B are examples of a plurality of template regions according to an embodiment of this disclosure.

As shown in FIGS. 15A and 15B, differentiated weighting is performed on a plurality of template regions of a current block based on a size of the current block. A template region closer to a longer side has a larger cost weight. For example, when a width of the current block is greater than a height, for two template regions shown in FIG. 15A, W1>W2, or for three template regions shown in FIG. 15B, W1>W2=W3; when the height of the current block is greater than the width, for two template regions shown in FIG. 15A, W2>W1, or for three template regions shown in FIG. 15B, W2>W1=W3; and when the width is equal to the height, for two template regions shown in FIG. 15A, W1=W2, or for three template regions shown in FIG. 15B, W1=W2=W3.

For example, the prediction apparatus determines cost weights of a plurality of template regions based on the plurality of template regions of the current block; and weighting template costs of the plurality of template regions relative to any candidate search point in the at least one candidate search point based on the cost weights of the plurality of template regions, to obtain a template cost of any candidate search point. The cost weight of the first template region is negatively correlated with a first distance.

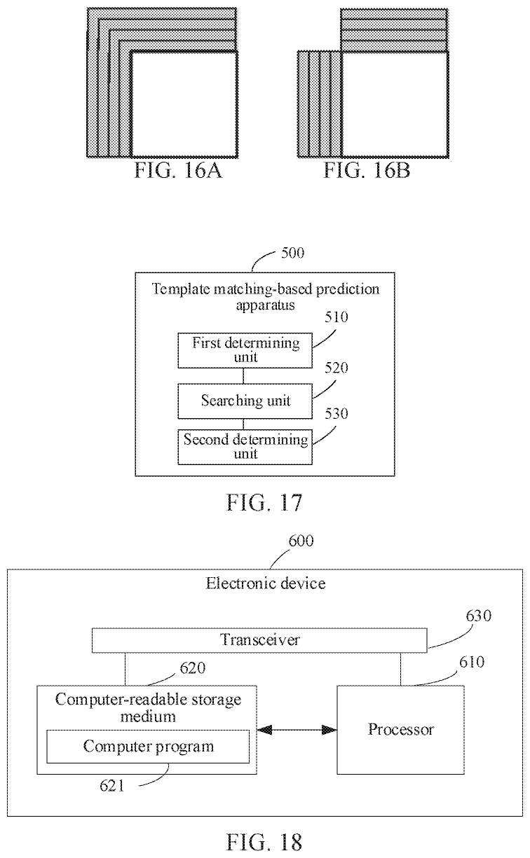

FIGS. 16A-16B are other examples of a plurality of template regions according to an embodiment of this disclosure.

As shown in FIGS. 16A and 16B, differentiated weighting is performed on template regions of a current block based on distances from the current block. For example, as shown in FIG. 16A or FIG. 16B, assuming that a template of the current block is divided into 4 template regions (which may also be referred to as 4 types of template regions or 4 sub-regions) based on the distances from the current block, costs of different template regions may be separately calculated and then weighted. A smaller distance from the current block indicates a larger cost weight. For example, the cost weight may be set to (1, 2, 3, 4) or (1, 2, 2, 3) in descending order of the distances.

In some embodiments, the first size and the first distance involved above may also be combined. When the width and the height are equal, the first distance is the primary consideration. When the width and the height are not equal, based on the first distance, the template region close to the long side is assigned a larger cost weight.

In some embodiments, S430 includes any one of the following:

determining, as a prediction block of the current block, a first prediction block to which the second vector points;

fusing the first prediction block to which the second vector points and a prediction block to which at least one vector points, to obtain a prediction block of the current block, a fusion weight of the first prediction block being equal to a fusion weight of a prediction block to which any vector in the at least one vector points, or the fusion weight of the first prediction block and the fusion weight of the prediction block to which any vector points being negatively correlated with a template cost; and

the at least one vector includes at least one of the following:

vectors searched based on the first starting search point other than the second vector;

a third vector included in the first VP other than the first vector;

a fourth vector obtained by determining a second starting search point based on the third vector and searching the search region through a template of the current block based on the second starting search point;

vectors searched based on the second starting search point other than the fourth vector;

a fifth vector included in a second VP in the VP list other than the first VP; or

a sixth vector obtained by determining a third starting search point based on the fifth vector and searching the search region through the template of the current block based on the third starting search point.

For example, vectors other than the second vector that are searched based on the first starting search point may be one or more sub-optimal candidate search points other than the first optimal search point that are selected in ascending order of template costs from the at least one candidate search point involved above, and one or more vectors that are determined based on the one or more sub-optimal candidate search points.

For example, a method for determining vectors other than the fourth vector that are searched based on the second starting search point may be the same as or different from a method for determining vectors other than the second vector that are searched based on the first starting search point. Examples described above are non-limiting examples and are not intended to limit the scope of this disclosure.

For example, the prediction apparatus may determine, as a prediction block of the current block, a first prediction block to which the second vector points. In some examples, the prediction apparatus may perform template matching optimization on the first vector to obtain the second vector, and determine, as the prediction block of the current block, the first prediction block to which the second vector points. For example, when the first VP includes only the first vector, the prediction apparatus may determine, as a prediction block of the current block, a first prediction block to which the second vector points.

For example, the prediction apparatus may fuse the first prediction block to which the second vector points and at least one of the following prediction blocks, to obtain a prediction block of the current block: a prediction block to which vectors other than the second vector that are searched based on the first starting search point, a prediction block to which the third vector points, a prediction block to which the fourth vector points, a prediction block to which vectors other than the fourth vector that are searched based on the second starting search point, a prediction block to which the fifth vector points, and a prediction block to which the sixth vector points.

An example in which the first prediction block and the prediction block to which the fourth vector points are fused is used. The prediction apparatus may fuse the first prediction block and the prediction block to which the fourth vector points, to obtain the prediction block of the current block. In some examples, the prediction apparatus may first perform template matching optimization on the first vector to obtain the second vector, perform template matching optimization on the third vector to obtain a fourth vector, and then fuse the first prediction block and the prediction block to which the fourth vector points, to obtain the prediction block of the current block. For example, when the first VP includes the third vector, the prediction apparatus may fuse the first prediction block and the prediction block to which the fourth vector points, to obtain the prediction block of the current block. A fusion weight of the first prediction block is equal to a fusion weight of the prediction block to which the fourth vector points, or the fusion weight of the first prediction block and the fusion weight of the prediction block to which the fourth vector points are negatively correlated with a template cost. For example, the fusion weight of the first prediction block is negatively correlated with the template cost of the first prediction block, and the fusion weight of the prediction block to which the fourth vector points is negatively correlated with the template cost of the prediction block to which the fourth vector points.

For example, the at least one vector is indicated through an identifier, and the identifier is carried in a bitstream or is determined through derivation by a decoder side.

This disclosure does not limit a manner of determining the at least one vector. For example, the prediction apparatus may determine the at least one vector based on a size of the current block, a quantity of vectors included in the first VP, or other information.

In some embodiments, the method 400 further includes at least one of the following:

searching, based on the second starting search point, for a second optimal search point having a minimum template cost, searching, based on an optimal search point in the second optimal search point and the first optimal search point that has a maximum template cost, for a third optimal search point that has a minimum template cost obtained after the template and the first template are fused, and updating the optimal search point having the maximum template cost to the third optimal search point; or

searching, based on the second starting search point, for a candidate search point having a minimum template cost obtained after the template and a template of the first optimal search point are fused, to obtain the second optimal search point.

The first template is a template of the optimal search point having the minimum template cost in the first optimal search point and the second optimal search point, and the first optimal search point is a candidate search point having the minimum template cost searched based on the first starting search point.

For example, the template cost obtained after fusion with the first template refers to a degree of difference between a fusion template obtained by fusion of the searched template and the first template and the template of the current block. Similarly, the template cost obtained after fusion with the template of the first optimal search point refers to a degree of difference between a fusion template obtained by fusion of the searched template and the template of the first optimal search point and the template of the current block.

The first VP is used as an MVP. The first VP includes a bidirectional motion vector (namely, two motion vectors). The prediction apparatus may optimize the two motion vectors separately through template matching, and then fuse the obtained two prediction blocks through bidirectional motion vector prediction, which may include weighting processing. In an example, the two motion vectors are first optimized through template matching, and then template costs of the two motion vectors are compared. If the two template costs are not equal, a coupled search may be performed. An optimized motion vector (MV1) having a relatively low cost remains unchanged (namely, the template P1 remains unchanged), and then an optimal matching template (P2′) continues to be searched based on an optimized motion vector (MV2) having a relatively high cost through template matching. However, in this case, a degree of difference between the template and the matching template is no longer used as a cost, but a degree of difference between a fusion template obtained after P1 and P2′ are fused and the template of the current block is calculated as the cost. A search method is consistent with or similar to the foregoing search method, and a bidirectional motion vector (MV1, MV2′) after optimization of the coupled search is finally obtained.

In some embodiments, S410 includes:

determining the first starting search point based on the first vector when at least one of the following is satisfied:

a second identifier indicates to search for a vector of the current block through the template of the current block, the second identifier being carried in the bitstream or determined through derivation by the decoder side;

a third identifier carried in the bitstream indicates that a current sequence of pictures, a current picture, or a current slice to which the current block belongs allows searching for the vector of the current block through the template of the current block;

a prediction mode of the current block is an inter prediction mode or an intra block copy prediction mode; or

a current prediction mode is an inter prediction mode, and a reference frame list of the current block includes a forward reference frame and a backward reference frame.

For example, when the current prediction mode is the inter prediction mode, and the reference frame list of the current block includes the forward reference frame and the backward reference frame, the prediction apparatus determines the first starting search point based on the first vector. When the current prediction mode is the inter prediction mode, and the reference frame list of the current block includes only the forward reference frame, the prediction apparatus does not trigger the process of determining the first starting search point based on the first vector. Alternatively, when the current prediction mode is the inter prediction mode, and the reference frame list of the current block includes the forward reference frame and the backward reference frame, the prediction apparatus optimizes the first vector based on template matching. When the current prediction mode is the inter prediction mode, and the reference frame list of the current block includes only the forward reference frame, the prediction apparatus prohibits optimization of the first vector.

For example, the third identifier is carried in the bitstream or determined through derivation by the decoder side.

In some embodiments, S420 includes:

searching the reference region for the second vector through parameter information carried in the bitstream; and

the parameter information includes at least one of the following:

a maximum quantity of iterations used in an iterative search, a maximum quantity of search points used in the iterative search, a search method used in the iterative search, or a calculation manner of the template cost.

The aspects described in this disclosure are described in further detail above with reference to the drawings. However, this disclosure is not limited to the specific aspects in the above implementations. A plurality of variations may be made to the technical solutions of this disclosure within the scope of the technical concept of this disclosure, and the variations fall within the scope of this disclosure. For example, the specific technical features described in the above specific implementations may be combined in any proper manner in case of no contradiction. To avoid unnecessary repetition, possible combinations are not described in this disclosure. For another example, various different implementations of this disclosure may be combined in different ways without departing from the idea of this disclosure, and the combinations are still regarded as the content disclosed in this disclosure.

The sequence numbers of the processes in the method embodiments of this disclosure do not mean execution sequences. The execution sequences of the processes are determined based on functions and internal logic of the processes, and are not construed as any limitation on the implementation processes of one or more embodiments of this disclosure.

The methods provided in one or more embodiments of this disclosure are described above. Apparatuses provided in one or more embodiments of this disclosure are described below.

FIG. 17 is a schematic block diagram of a template matching-based prediction apparatus 500 according to an embodiment of this disclosure.

As shown in FIG. 17, the prediction apparatus 500 includes:

a first determining unit 510, configured to determine a first starting search point based on a first vector included in a first vector prediction (VP) in a vector prediction (VP) list of a current block;

a searching unit 520, configured to search, based on the first starting search point, a reference region of the current block for a second vector of the current block through a template formed by reconstructed pixels adjacent to the current block; and

a second determining unit 530, configured to determine a prediction block of the current block based on the second vector.

In some embodiments, the first VP is indicated through a first identifier, the first identifier being carried in a bitstream or determined through derivation by a decoder side, or the first VP is a VP having a minimum template cost in the VP list.

In some embodiments, when the first identifier is carried in the bitstream, a codeword length of the first identifier is positively correlated with a template cost of the first VP.

In some embodiments, before determining the first starting search point, the first determining unit 510 is further configured to:

construct an initial list based on at least one of an adjacent space-domain VP, a time-domain VP, a non-adjacent space-domain VP, a history-based VP, an average VP, or a zero-vector VP; and

perform at least one of deduplication, vector adjustment, template cost evaluation, or template cost-based ordering on initial VPs in the initial list, to obtain the VP list.

In some embodiments, the first determining unit 510 is configured to:

determine, as the first starting search point, a position to which the first vector points; or

adjust the first vector along at least one dimension to obtain an adjusted vector of the first vector, and determine, as the first starting search point, a position to which the adjusted vector points.

In some embodiments, the first determining unit 510 is configured to perform at least one of the following:

adjusting the first vector along the at least one dimension based on a vector difference VD of the first vector, to obtain the adjusted vector;

determining a quantity of shift bits based on the first vector, performing right shift calculation on the first vector along the at least one dimension based on the quantity of shift bits, and performing left shift calculation on a calculation result obtained after a right shift based on the quantity of shift bits, to obtain the adjusted vector;

adjusting the first vector along the at least one dimension to point to an integer-pixel position closest to the position to which the first vector points, to obtain the adjusted vector; or

offsetting the first vector along the at least one dimension based on a preset offset, to obtain the adjusted vector.

In some embodiments, the searching unit 520 is configured to:

search for at least one candidate search point based on the first starting search point; and

adjust the first vector to point to a first optimal search point having a minimum template cost in the at least one candidate search point, to obtain the second vector.

In some embodiments, the searching unit 520 is configured to perform at least one of the following:

obtaining the at least one candidate search point through traversal search of candidate search points; or

performing, based on the first starting search point and a first search shape used by the current block, an iterative search on a candidate search point having a minimum template cost, to obtain candidate search points obtained in a current iteration process, and determining, as the first optimal search point, a candidate search point having the minimum template cost that is obtained in the current iteration process until a preset condition is satisfied.

In some examples, a traversal search of the first reference region is performed to obtain the at least one candidate search point. In some examples, an iterative search that includes a plurality of search iterations is performed based on the first starting search point and a first search shape used by the current block to obtain the at least one candidate search point, a candidate search point having a minimum template cost in a current search iteration of the plurality of search iterations being usable as a next starting search point in a next search iteration of the plurality of search iterations until a preset condition is satisfied. In some examples, the plurality of search iterations is performed based on a search method that includes at least one search shape and a quantity of iterations corresponding to each of the at least one search shape, the at least one search shape including the first search shape.

The preset condition includes at least one of the following:

the candidate search point having the minimum template cost that is obtained in the current iteration process is a starting search point used in the current iteration process;

a quantity of iterations that have been performed is greater than or equal to a maximum quantity of iterations; or

a quantity of points that have been searched is greater than or equal to a maximum quantity of search points.

In some embodiments, the searching unit 520 is configured to:

perform, based on the first starting search point and a search method used by the current block, the iterative search on the candidate search point having the minimum template cost, to obtain candidate search points obtained in the current iteration process.

The search method includes at least one search shape and a quantity of iterations corresponding to each of the at least one search shape, the at least one search shape including the first search shape.

In some embodiments, the searching unit 520 is configured to:

perform, based on the first search shape, a first iteration process on the candidate search point having the minimum template cost, to obtain candidate search points obtained in the first iteration process, and perform, based on the candidate search point having the minimum template cost in the candidate search points obtained in the first iteration process, a second iteration process on the candidate search point having the minimum template cost, to obtain candidate search points obtained in the second iteration process;

determine, when a first candidate search point obtained in the first iteration process overlaps with a second candidate search point obtained in the second iteration process, a template cost of the first candidate search point as a template cost of the second candidate search point; or

ignore the second candidate search point when the first candidate search point overlaps with the second candidate search point and the second candidate search point is not the starting search point used in the second iteration process, or determine, based on candidate search points obtained in the second iteration process other than the second candidate search point, the candidate search point having the minimum template cost in the second iteration process.

In some embodiments, an absolute value of a first offset of any candidate search point in the at least one candidate search point is less than or equal to a third preset threshold, or an absolute value of a second offset of any candidate search point is less than or equal to a fourth preset threshold, or a sum of the absolute value of the first offset and the absolute value of the second offset of any candidate search point is less than or equal to a fifth preset threshold; and

the first offset is an offset of any candidate search point relative to the first starting search point in a first dimension, and the second offset is an offset of any candidate search point relative to the first starting search point in a second dimension.

In some embodiments, before obtaining the second vector, the searching unit 520 is further configured to:

determine cost weights of a plurality of template regions based on the plurality of template regions of the current block; and

weight template costs of the plurality of template regions relative to any candidate search point in the at least one candidate search point based on the cost weights of the plurality of template regions, to obtain a template cost of any candidate search point.

A cost weight of a first template region in the plurality of template regions satisfies at least one of the following:

the cost weight of the first template region is positively correlated with a first size, the first size being a size of a length of a side of the current block adjacent to the first template region; or

the cost weight of the first template region is negatively correlated with a first distance, the first distance being a distance between the first template region and the current block.

In some embodiments, the second determining unit 530 is configured to perform any one of the following:

determining, as a prediction block of the current block, a first prediction block to which the second vector points;

fusing the first prediction block to which the second vector points and a prediction block to which at least one vector points, to obtain a prediction block of the current block, a fusion weight of the first prediction block being equal to a fusion weight of a prediction block to which any vector in the at least one vector points, or the fusion weight of the first prediction block and the fusion weight of the prediction block to which any vector points being negatively correlated with a template cost; and

the at least one vector includes at least one of the following:

vectors searched based on the first starting search point other than the second vector;

a third vector included in the first VP other than the first vector;

a fourth vector obtained by determining a second starting search point based on the third vector and searching the search region through a template of the current block based on the second starting search point;

vectors searched based on the second starting search point other than the fourth vector;

a fifth vector included in a second VP in the VP list other than the first VP; or

a sixth vector obtained by determining a third starting search point based on the fifth vector and searching the search region through the template of the current block based on the third starting search point.

In some embodiments, the searching unit 520 is further configured to perform at least one of the following:

searching, based on the second starting search point, for a second optimal search point having a minimum template cost, searching, based on an optimal search point in the second optimal search point and the first optimal search point that has a maximum template cost, for a third optimal search point that has a minimum template cost obtained after the template and the first template are fused, and updating the optimal search point having the maximum template cost to the third optimal search point; or

searching, based on the second starting search point, for a candidate search point having a minimum template cost obtained after the template and a template of the first optimal search point are fused, to obtain the second optimal search point.

The first template is a template of the optimal search point having the minimum template cost in the first optimal search point and the second optimal search point, and the first optimal search point is a candidate search point having the minimum template cost searched based on the first starting search point.

In some embodiments, the first determining unit 510 is configured to:

determine the first starting search point based on the first vector when at least one of the following is satisfied:

a second identifier indicates to search for a vector of the current block through the template of the current block, the second identifier being carried in the bitstream or determined through derivation by the decoder side;

a third identifier carried in the bitstream indicates that a current sequence of pictures, a current picture, or a current slice to which the current block belongs allows searching for the vector of the current block through the template of the current block;

a prediction mode of the current block is an inter prediction mode or an intra block copy prediction mode; or

a current prediction mode is an inter prediction mode, and a reference frame list of the current block includes a forward reference frame and a backward reference frame.

In some examples, a third identifier may indicate that searching for the vector of the current block through the template of the current block is enabled for a current sequence of pictures, a current picture, or a current slice to which the current block belongs, the third identifier being carried in the bitstream.

In some embodiments, the searching unit 520 is configured to:

search the reference region for the second vector through parameter information carried in the bitstream; and

the parameter information includes at least one of the following:

a maximum quantity of iterations used in an iterative search, a maximum quantity of search points used in the iterative search, a search method used in the iterative search, or a calculation manner of the template cost.

The prediction apparatus 500 provided in this embodiment of this disclosure may correspond to an execution subject in the method embodiments of this disclosure, and units in the prediction apparatus 500 are respectively configured to implement a corresponding process of the prediction method 400 shown in FIG. 11. For brevity, details are not described herein again.

The prediction apparatus provided in this embodiment of this disclosure can implement the processes in the method embodiment of FIG. 11 and achieve the same technical effect. To avoid repetition, details are not described herein again.

The units in the prediction apparatus 500 involved in one or more embodiments of this disclosure are divided based on logical functions. In actual disclosure, functions of one unit may also be implemented by a plurality of units, or functions of a plurality of units may be implemented by one unit, or even these functions may alternatively be implemented with the assistance of one or more other units. For example, a part or all of the prediction apparatus 500 is combined into one or several other units. For another example, one (some) unit (units) in the prediction apparatus 500 may be further split into a plurality of units with smaller functions, so as to realize the same operation without affecting the implementation of the technical effects of one or more embodiments of this disclosure. For another example, the prediction apparatus 500 may include another unit. In actual application, these functions may be implemented with assistance of other units, and may be implemented through cooperation of a plurality of units.

A term “module” or “unit” as described in this disclosure may be implemented by processing circuitry, software stored in a non-transitory computer-readable storage medium, or a combination thereof. A single processor or memory may implement one or more modules or units.

A term “module” or “unit” involved in one or more embodiments of this disclosure refers to a computer program or a part of the computer program that has a predetermined function and operates together with another relevant part to achieve a predetermined goal, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

According to one or more embodiments of this disclosure, a computer program (including program code) that can perform the operations involved in the corresponding methods may be run in a general-purpose computer device such as a general-purpose computer including processing elements such as a central processing unit (CPU), a random access memory (RAM), and a read-only memory (ROM) and storage elements, to construct the prediction apparatus 500 in one or more embodiments of this disclosure, and implement the method provided in one or more embodiments of this disclosure. The computer program may be recorded in, for example, a computer-readable storage medium, and loaded in an electronic device through the computer-readable storage medium. The computer program is configured to implement the corresponding methods in one or more embodiments of this disclosure. For example, the above units may be implemented in a form of hardware, or may be implemented by instructions in a form of software, or may be implemented in a form of a combination of hardware and software. In an example, the operations of the method embodiments in one or more embodiments of this disclosure may be completed through an integrated logic circuit of hardware in a processor and/or the instructions in the form of software. The operations of the method disclosed in combination with one or more embodiments of this disclosure may be directly performed by a hardware decoding processor, or may be performed through a combination of hardware and software in the decoding processor. In some embodiments, the software may be located in a mature storage medium in the art, such as a random access memory (RAM), a flash memory, a read-only memory (ROM), a programmable ROM, an electrically erasable programmable memory, or a register. The software in the memory can be run by a processor to perform the operations described in the method embodiments above.

FIG. 18 is a schematic structural diagram of an electronic device 600 according to this disclosure.

As shown in FIG. 18, the electronic device 600 includes at least a processor 610 and a computer-readable storage medium 620. The processor 610 and the computer-readable storage medium 620 may be connected by a bus or in another manner. The computer-readable storage medium 620 is configured to store a computer program 621. The computer program 621 includes computer instructions. The processor 610 is configured to execute the computer instructions stored in the computer-readable storage medium 620. The processor 610 is a computing core and a control core of the electronic device 600, and is configured to implement one or more computer instructions. In an example, the processor is configured to load and execute the one or more computer instructions to implement the corresponding method processes or corresponding functions.

The processor 610 may also be referred to as a central processing unit (CPU). The processor 610 may include but is not limited to a general-purpose processor, a digital signal processor (DSP), an application specific integrated circuit (ASIC), a field programmable gate array (FPGA), or another programmable logic device, a transistor logic device, a discrete hardware component, or the like.

The computer-readable storage medium 620 may be a high-speed random access memory (RAM), or a non-volatile memory, for example, at least one disk memory, and in some embodiments, may alternatively be at least one computer-readable storage medium away from the foregoing processor 610. In an example, the computer-readable storage medium 620 includes, but is not limited to, a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM that is used as an external cache. Through examples but not limitation, many forms of RAMs are available, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

As shown in FIG. 18, the electronic device 600 may further include a transceiver 630.

The processor 610 may control the transceiver 630 to communicate with another device, and in an example, may transmit information or data to another device, or receive information or data transmitted by another device. The transceiver 630 may include a transmitter and a receiver. The transceiver 630 may further include an antenna. One or more antennas may be arranged.

In one implementation, the electronic device 600 may be the prediction apparatus 500 involved in one or more embodiments of this disclosure. The computer-readable storage medium 620 has computer instructions stored therein. The processor 610 loads and executes the computer instructions stored in the computer-readable storage medium 620, to implement the corresponding operations in the prediction method 400 provided in this disclosure. For example, the computer instructions in the computer-readable storage medium 620 are loaded by the processor 610 and executed to implement the corresponding operations of the prediction method 400. To avoid repetition, details are not described herein again.

According to another aspect of this disclosure, this disclosure further includes an encoding and decoding system, including an encoder and a decoder described above.

According to another aspect of this disclosure, this disclosure further includes a non-transitory computer-readable storage medium (memory), having computer instructions stored therein, the computer instructions, when read and executed by a processor of a computer device, causing the computer device to perform the prediction method described above.

The computer-readable storage medium is a memory device in the decoder or the encoder, which is configured to store programs and data. The computer-readable storage medium herein may include a built-in storage medium of the electronic device, and in some examples may alternatively include an extended storage medium supported by the electronic device. The computer-readable storage medium may be configured to provide a storage space. The storage space may have an operating system of the electronic device stored therein. In addition, one or more computer instructions configured to be loaded and executed by the processor are further stored in the storage space. For example, one or more computer instructions for performing the prediction method described above are stored. These computer instructions may be one or more computer programs (including program code).

According to another aspect of this disclosure, this disclosure further includes a computer program product or a computer program. The computer program product or the computer program includes computer instructions, the computer instructions being stored in a non-transitory computer-readable storage medium. A processor of a computer device reads the computer instructions from the non-transitory computer-readable storage medium. The processor executes the computer instructions, so that the computer device performs the prediction method described in the various alternatives above.

The computer device involved in this disclosure may be any one type of device or apparatus that can perform data processing, for example, but not limited to, a general-purpose computer, a special-purpose computer, a computer network, or another programmable apparatus. In addition, the computer instructions involved in this disclosure may be stored in the computer-readable storage medium, or may be transmitted from a computer-readable storage medium to another computer-readable storage medium. For example, the computer instructions may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner).

According to another aspect of this disclosure, this disclosure further includes a bitstream. The bitstream may be decoded by using the prediction method described in this disclosure, or the bitstream is generated by using the prediction method described in this disclosure.

A person of ordinary skill in the art may be aware that, the units and the process operations of the examples described in combination with the embodiments disclosed in this disclosure may be implemented by electronic hardware or a combination of computer software and electronic hardware. Whether the functions are performed by hardware or software depends on particular applications and design constraints of the technical solutions. A person skilled in the art may use different methods to implement the described functions for each specific application, but it is not considered that such implementation goes beyond the scope of this disclosure.

Finally, the foregoing descriptions are merely specific implementations of this disclosure, and are not intended to limit the scope of this disclosure. Any variation or replacement within the technical scope disclosed in this disclosure falls within the scope of this disclosure.

What is claimed is:

1. A video decoding method, comprising:
determining a first starting search point in a first reference picture based on a first vector included in a first vector prediction list of a current block in a current picture;
searching, based on the first starting search point, a first reference region of the current block for a second vector through a template of reconstructed pixels adjacent to the current block;
determining a second starting search point in a second reference picture based on a third vector included in the first vector prediction list or a second vector prediction list of the current block that is different from the first vector prediction list;
searching, based on the second starting search point, a second reference region of the current block for a fourth vector through the template of reconstructed pixels adjacent to the current block;
obtaining a prediction block of the current block based on fusing a first prediction block indicated by the second vector and a second prediction block indicated by the fourth vector; and
reconstructing the current block based on the prediction block.

2. The method according to claim 1, wherein
the first vector is indicated by a first identifier, the first identifier being carried in a bitstream or determined through derivation by a decoder side; or
the first vector is a vector having a minimum template cost in the first vector prediction list.

3. The method according to claim 2, wherein, when the first identifier is carried in the bitstream, a codeword length of the first identifier is positively correlated with a template cost of the first vector.

4. The method according to claim 1, further comprising:
constructing an initial list based on at least one of an adjacent space-domain vector prediction, a time-domain vector prediction, a non-adjacent space-domain vector prediction, a history-based vector prediction, an average vector prediction, or a zero-vector vector prediction; and
performing at least one of deduplication, vector adjustment, template cost evaluation, or template cost-based ordering on vectors in the initial list, to obtain the first vector prediction list.

5. The method according to claim 1, wherein the determining the first starting search point comprises:
determining, as the first starting search point, a position to which the first vector points; or
adjusting the first vector along at least one dimension to obtain an adjusted vector of the first vector, and determining, as the first starting search point, a position to which the adjusted vector points.

6. The method according to claim 5, wherein the adjusting the first vector along the at least one dimension comprises at least one of:
adjusting the first vector along the at least one dimension based on a vector difference of the first vector, to obtain the adjusted vector;
determining a quantity of shift bits based on a target precision, performing right shift operation followed by a left shift operation on the first vector along the at least one dimension based on the quantity of shift bits, to obtain the adjusted vector;
adjusting the first vector along the at least one dimension to point to a closest integer-pixel position, to obtain the adjusted vector; or
offsetting the first vector along the at least one dimension based on a preset offset, to obtain the adjusted vector.

7. The method according to claim 1, wherein the searching the first reference region comprises:
performing a template-based search on at least one candidate search point based on the first starting search point; and
obtaining the second vector that points to a first optimal search point having a minimum template cost in the at least one candidate search point.

8. The method according to claim 7, wherein the performing the template-based search on at least one candidate search point comprises:
performing a traversal search of the first reference region to obtain the at least one candidate search point; or
performing an iterative search that includes a plurality of search iterations based on the first starting search point and a first search shape used by the current block to obtain the at least one candidate search point, a candidate search point having a minimum template cost in a current search iteration of the plurality of search iterations being usable as a next starting search point in a next search iteration of the plurality of search iterations until a preset condition is satisfied, wherein
the preset condition comprises at least one of:
the candidate search point having the minimum template cost in the current search iteration is a starting search point used in the current search iteration;
a quantity of iterations that have been performed is greater than or equal to a maximum quantity of iterations; or
a quantity of search points that have been searched is greater than or equal to a maximum quantity of search points.

9. The method according to claim 8, wherein
the plurality of search iterations is performed based on a search method that includes at least one search shape and a quantity of iterations corresponding to each of the at least one search shape, the at least one search shape including the first search shape.

10. The method according to claim 8, wherein the performing the plurality of search iterations comprises:
performing, based on the first starting search point and the first search shape, a first iteration process to obtain a first set of candidate search points;
performing, based on a candidate search point having the minimum template cost in the first iteration process as a next starting search point, a second iteration process to obtain a second set of candidate search points; and
at least one of:
determining, when a first candidate search point obtained in the first iteration process overlaps a second candidate search point obtained in the second iteration process, a template cost of the first candidate search point as a template cost of the second candidate search point; or
ignoring the second candidate search point when the first candidate search point overlaps the second candidate search point and the second candidate search point is not the next starting search point used in the second iteration process, or determining, based on other candidate search points obtained in the second iteration process other than the second candidate search point, a candidate search point having the minimum template cost in the second iteration process.

11. The method according to claim 7, wherein
an absolute value of a first offset of any candidate search point in the at least one candidate search point is less than or equal to a third threshold, or an absolute value of a second offset of any candidate search point in the at least one candidate search point is less than or equal to a fourth threshold, or a sum of the absolute value of the first offset and the absolute value of the second offset of any candidate search point is less than or equal to a fifth threshold; and
the first offset is an offset of any candidate search point relative to the first starting search point in a first dimension, and the second offset is an offset of any candidate search point relative to the first starting search point in a second dimension.

12. The method according to claim 7, further comprising:
determining cost weights of a plurality of template regions of the current block; and
obtaining a template cost of a candidate search point of the at least one candidate search point that is weighted based the cost weights of the plurality of template regions, wherein
a first cost weight of a first template region in the plurality of template regions satisfies at least one of:
the first cost weight of the first template region being positively correlated with a first size, the first size being a size of a length of a side of the current block adjacent to the first template region; or
the first cost weight of the first template region being negatively correlated with a first distance, the first distance being a distance between the first template region and the current block.

13. The method according to claim 7, further comprising:
searching for a second optimal search point having a minimum template cost based on the second starting search point, and searching for an updated optimal search point that has a minimum template cost obtained after the template and a first template are fused based on one of the first optimal search point and the second optimal search point having a greater template cost, the first template being a template of one of the first optimal search point and the second optimal search point having a lower template cost; or
searching for the second optimal search point having a minimum template cost obtained after the template and a template of the first optimal search point are fused.

14. The method according to claim 1, wherein
a fusion weight of the first prediction block is equal to a fusion weight of the second prediction block, or the fusion weight of the first prediction block and the fusion weight of the second prediction block are negatively correlated with corresponding template costs.

15. The method according to claim 1, wherein the first starting search point is determined based on the first vector when at least one of:
a second identifier indicating searching for a vector of the current block through the template of the current block, the second identifier being carried in a bitstream or determined through derivation by a decoder side;
a third identifier indicating that searching for the vector of the current block through the template of the current block is enabled for a current sequence of pictures, a current picture, or a current slice to which the current block belongs, the third identifier being carried in the bitstream;
a prediction mode of the current block being an inter prediction mode or an intra block copy prediction mode; or
a current prediction mode being an inter prediction mode, and a reference frame list of the current block including a forward reference frame and a backward reference frame.

16. The method according to claim 1, wherein
the searching the first reference region of the current block for the second vector of the current block includes searching the reference region for the second vector based on parameter information carried in a bitstream; and
the parameter information includes at least one of a maximum quantity of iterations used in an iterative search, a maximum quantity of search points used in the iterative search, a search method used in the iterative search, or a calculation manner of a template cost.

17. A video encoding method, comprising:
determining a first starting search point in a first reference picture based on a first vector included in a first vector prediction list of a current block in a current picture;
searching, based on the first starting search point, a first reference region of the current block for a second vector through a template of reconstructed pixels adjacent to the current block;
determining a second starting search point in a second reference picture based on a third vector included in the first vector prediction list or a second vector prediction list of the current block that is different from the first vector prediction list;
searching, based on the second starting search point, a second reference region of the current block for a fourth vector through the template of reconstructed pixels adjacent to the current block;
obtaining a prediction block of the current block based on fusing a first prediction block indicated by the second vector and a second prediction block indicated by the fourth vector; and
encoding the current block into a bitstream based on the prediction block.

18. The method according to claim 17, wherein the searching the first reference region comprises:
performing a template-based search on at least one candidate search point based on the first starting search point;
obtaining the second vector that points to a first optimal search point having a minimum template cost in the at least one candidate search point; and
at least one of:
searching for a second optimal search point having a minimum template cost based on the second starting search point, and searching for an updated optimal search point that has a minimum template cost obtained after the template and a first template are fused based on one of the first optimal search point and the second optimal search point having a greater template cost, the first template being a template of one of the first optimal search point and the second optimal search point having a lower template cost; or
searching for the second optimal search point having a minimum template cost obtained after the template and a template of the first optimal search point are fused.

19. The method according to claim 17, wherein
a fusion weight of the first prediction block is equal to a fusion weight of the second prediction block, or the fusion weight of the first prediction block and the fusion weight of the second prediction block are negatively correlated with corresponding template costs.

20. A non-transitory computer-readable storage medium storing instructions which, when executed by a processor, cause the processor to perform a method of encoding a bitstream, the method comprising:
determining a first starting search point in a first reference picture based on a first vector included in a first vector prediction list of a current block in a current picture;
searching, based on the first starting search point, a first reference region of the current block for a second vector through a template of reconstructed pixels adjacent to the current block;
determining a second starting search point in a second reference picture based on a third vector included in the first vector prediction list or a second vector prediction list of the current block that is different from the first vector prediction list;
searching, based on the second starting search point, a second reference region of the current block for a fourth vector through the template of reconstructed pixels adjacent to the current block;
obtaining a prediction block of the current block based on fusing a first prediction block indicated by the second vector and a second prediction block indicated by the fourth vector;
encoding the current block into a bitstream based on the prediction block; and
transmitting the encoded bitstream.
